(19) United States
(12) Patent Application Publication
(10) Pub. No.: US 2012/0149456 A1
(43) Pub. Date: Jun. 14, 2012

(54) GAMING SYSTEM WITH SERVER-CENTRIC ARCHITECTURE

(76) Inventor: John F. Acres, Las Vegas, NV (US)

(21) Appl. No.: 12/965,466

(22) Filed: Dec. 10, 2010

(51) Int. Cl. G06F 17/00

(52) U.S. Cl. 463/25; 463/42; 463/31; 463/30

(57) ABSTRACT

Embodiments of the present invention are directed to gaming systems that utilize a server and one or more gaming stations in a server-centric type architecture. In one example, gaming system includes a central game server that has multiple circuit cards each having a processor and a memory, as well as a set of redundant circuit cards respectively paired with each of the multiple circuit cards. The central game server is connected to at least one game device terminal through a network, where all game play occurring on the game device terminal is controlled by the central game server.

### FIELD OF THE INVENTION

This disclosure relates generally to a gaming system, and more particularly to gaming system that utilizes a server and one or more gaming stations in a server-centric type architecture.

### BACKGROUND

Traditionally, gaming devices have been independent machines that are configured to play a single type of wager-based game. Casinos typically bought a variety of game types to satisfy players with different preferences. When a new game style or title appeared, or an older game began losing favor with players, it was relatively expensive for the casino to buy a new gaming machine to replace the older game machine. As gaming technology progressed, complete games could be loaded on memory chips and inserted into a gaming machine, or otherwise transferred from a storage device to the memory in a gaming device to change the style of game play. Removable glass graphics could be replaced to give the gaming device a new look to go along with the new game theme. This advance reduced the material cost of replacing games, but it still required down time for the gaming devices while the update took place and the theme and style of the game was set on that gaming machine until the next time it was changed by casino personnel.

Some gaming companies developed gaming devices that held several different games, from which a player could select one to play. All of the game code and logic was stored in the memory of the game device. Thus, while this notion gave the player some flexibility in the type of game to play, the list of available games was often short and types of games were often not the latest games because of the limited memory and processing power of the game device.

Another advancement put forward to allow players an increase in the flexibility of selecting games was the idea of “server-based” gaming. In server-based gaming, a player is able to download a game theme from a remote server to a gaming device so that the selected game can be played at the gaming device. This style of gaming had the advantage of allowing players to simply select the game they wanted to play at a location they were already at. Theoretically, a player would have more choices in the games they played, and would not have to waste time searching for a particular game device or waiting while another player was playing a gaming device with the desired game theme. Server-based gaming, however, requires time for a new game to be downloaded and implemented on a new gaming device. Often times, this transfer and installation process can take a substantial amount of time, leaving players wondering why they didn't simply get up and look for the game theme that they wanted to play on some other machine.

### BRIEF DESCRIPTION OF THE DRAWINGS

FIG. 1 is a system diagram illustrating a gaming system with a server-centric architecture according to embodiments of the invention.

FIG. 2 is a detail diagram of a server in the gaming system illustrated in FIG. 1 according to embodiments of the invention.

FIG. 3A is a detail diagram of a gaming device terminal in the gaming system illustrated in FIG. 1 according to embodiments of the invention.

FIG. 3B is a perspective view of a wireless gaming device terminal according to embodiments of the invention.

FIG. 3C is a detail diagram of a display of a gaming device terminal showing an exemplary game library screen according to embodiments of the invention.

FIG. 3D is a detail diagram of a display of a gaming device terminal showing an exemplary game review screen according to embodiments of the invention.

FIG. 4A is a flow diagram of a method of operating a gaming system to determine availability of a gaming device terminal according to embodiments of the invention.

FIG. 4B is a flow diagram of a method of operating a gaming system during game play according to embodiments of the invention.

FIG. 5A is a flow diagram of a method of inputting credits into a player credit account in a gaming system according to embodiments of the invention.

FIG. 5B is a flow diagram of a method of removing credits from a player credit account in a gaming system according to embodiments of the invention.

FIG. 6A is a functional block diagram of a memory associated with a server in a gaming system according to embodiments of the invention.

FIG. 6B is a flow diagram of a method of writing game data to a memory associated with a server in a gaming system according to embodiments of the invention.

FIG. 7 is a system diagram illustrating various components of a gaming system according to embodiments of the invention.

FIG. 8 is a functional block diagram that illustrates an example gaming device that can be a part of the gaming system shown in FIG. 7.

FIG. 9A is a block diagram of an example machine interface device shown in FIG. 7 according to embodiments of the invention.

FIG. 9B is a block diagram of an example processor in the machine interface device illustrated in FIG. 9A according to embodiments of the invention.

FIG. 10 is a block diagram of an example bonus controller shown in FIG. 7 according to embodiments of the invention.

### DETAILED DESCRIPTION

As discussed above, conventional gaming machines and systems are limited in their ability to provide multiple game types to a player at a single gaming device. Embodiments of the present concept provide a game system with a server-centric architecture that allows players to play games on many different types of gaming devices, as well as allowing players to choose what game to play at a gaming device from a library of possible games. Unlike server-based gaming, where an entire game is downloaded to a gaming machine and then operated at the gaming machine, embodiments that utilize server-centric architecture control game play at gaming device terminals at a central game server.

Some server-centric gaming systems may have complete control over all game play on game devices, where the gaming server controls all game play functions on a game device. However, in other server-centric gaming systems, a gaming server may only control a portion of game play. For ease of reference, these types of systems will be referred to as hybrid server-centric gaming systems. All references to “server-centric gaming systems” in this disclosure applies to both complete control systems and hybrid systems. Although some game play features may be carried out at a gaming device, the severing of a connection between the gaming server and the gaming device would still cause game play on the gaming device to cease. In one example, an existing mechanical reel spinning gaming device may be implemented in a server-centric system where the existing game device controls the display of the game play and the game outcome in response to a random number generated at a gaming server and sent to the gaming device. Here, although the actual game result may be determined at the game device level, this game result is only determined as a result of the random numbers received from the gaming server. That is, the gaming server sends three random numbers that represent the reel stop locations for a game result. The gaming device takes those random reel stop locations and determines if such a combination results in a winning game outcome associated with an award. The gaming device also controls the stepper motors that drive the spinning reels to the correct stop locations.

Server-centric gaming systems have many advantages over server-based gaming systems. Some of these advantages include flexibility in implementing the system with a variety of gaming devices, improved security over game play, ability to provide a wide array of games, ease of updating current games or adding new games, ease in accounting and other game tracking metrics, and simplicity of casino floor implementation.

The ability to provide a flexible implementation of the system over a wide variety of gaming devices allows for implementation with current traditional gaming devices, but unlocks the possibilities in providing gaming on mobile gaming devices and remote gaming devices, such as wireless tablets, cell phones, and personal computers (e.g., Apple iPads, desktop computers, laptop computers, or other personal computing devices). Additionally, the flexibility afforded by the server-centric model allows for the ability to modify or add to the gaming system with relative ease. For example, a casino may implement a relatively basic server-centric system with traditional gaming devices, and then decide after a few months to incorporate wireless gaming devices to be used around the casino property into the gaming system. At still a later date, the casino could expand the system to include internet gaming or other remote types of gaming.

Improved system security is achieved by conducting decisions and control over game play at a central gaming sever rather than at multiple gaming devices. That is, in traditional gaming systems, security over game play must be controlled and monitored for each gaming device since game play is conducted at the gaming device level. These individual gaming devices may be subjected to various attacks via magnets, physical force, electric signals, or other types of intrusions that are intended to disrupt the game play results being calculated within the gaming device. With server-centric gaming, however, these intrusions have no effect on game play because it is carried out independently of the gaming device. Thus, for example, the casino would not have to monitor a wireless gaming device that a player could take back to their hotel room and possibly disassemble. Even if the player attempted to interfere with game play on the wireless device, her attempts would be fruitless because the gaming device has no control over game play.

In addition, large libraries of game types may be available for the player to play. And, unlike server-based games, there is no need to wait for a significant period of time after selecting a game to play game while the complete code for the game downloads from the server to the gaming device. This makes it easier for a player to switch between games or try out a new game. Additionally, when delivering a new game, there is no need to determine if each of the connected gaming devices will be able to implement the game play of the new game. Rather, the new game simply needs to work with the single system on the server.

In a basic embodiment, a server-centric gaming system needs only to include a server, a gaming device, and a connection between the server and the gaming device. For ease of understanding, a server in a server-centric gaming system will be referred to as a central gaming sever or CGS (these terms, along with central game server or game server, are used interchangeably in this disclosure). A gaming device in a server-centric gaming system will be referred to as a gaming device terminal or GDT (these terms, along with game device terminal, game device, or game terminal, are used interchangeably in this disclosure). A central gaming server may include many different functionalities in different embodiments, but it will be the server that controls game play at one or more gaming device terminals. Each gaming device terminal acts as a terminal for interfacing with a player for game play, but does not make any decisions regarding game outcomes on its own. As discussed and illustrated below, GDTs may take many different formats from conventional game devices under the control of a CGS to simple wireless touchscreen devices to personal computers.

As these are gaming devices meant to accept wagers on game play, a system is also needed to handle money or credits that may be used for placing wagers on the games of chance. Various systems of handling money/credits may be implemented with server-centric gaming systems. For ease of understanding, this disclosure will use the term “player credit account” (or PCA) to refer to all types of money/credit systems that keep track of the number of credits that a player may control.

In a server-centric gaming system implemented on more traditional gaming devices that have gaming cabinets with included bill/ticket validator and ticket printers (or coin slots and coin hoppers), the player credit account may simply be a local record of the credits available on that particular gaming device terminal. That is, while control of game play may be controlled by a CGS, credit management may remain at the gaming device terminal level. Here, credits added via the bill/ticket validator are added to the player credit account and credits wagered or cashed out are subtracted from the player credit account. During game play, the central gaming server provides instructions on adding additional credits from winning game outcomes or other bonuses. In some embodiments, the central gaming server may also provide instructions for deducting credits from wagers placed at the gaming device terminal. In other embodiments, however, the credits offered up in a wager may be deducted by the gaming device terminal independent of any instructions from the CGS. These types of player credit accounts may also be used with gaming device terminals that do not have a physical credit input/removal device, but allow a player to input a credit card number or other type of unique player identifier that allows money to be transferred to and from the gaming device terminal. For example, a player may use a touchscreen number pad to enter her credit card number and request $100 to be transferred to the gaming device terminal. The GDT may keep track of the amounts of money wagered and won during a game session. If the player has $80 remaining on their player credit account at the GDT when they decide to end the gaming session, the player may again enter her credit account number (or the GDT may simply remember which credit card number was used to add credits) to transfer the remaining $80 back to her credit card account. In each of these types of systems, the player credit account is typically associated with the gaming device terminal that the player is playing.

In server-centric gaming systems that include gaming device terminals without credit input or removal devices, an additional credit system may be implemented to facilitate a player credit account where wagers may be deducted and awards may be added. This additional credit system may be controlled by the central gaming server or may be controlled by another server. The additional credit system may be a casino-wide system, may include multiple casino properties, may include GDTs connected through the internet on a casino system, or may be independent of any casinos. In some embodiments, the credit system may allow requested amounts of credits to be “downloaded” to a particular GDT for a gaming session where the internal processor and memory of the GDT handles the credits once received from the credit system. In other embodiments, the credit system may be in frequent contact with the central gaming server and handle all credit reductions and additions. In each of these types of systems, the player credit account is typically associated with the player themselves rather than the gaming device terminal that the player is playing. This means that the player may have to take an additional step of associating their player credit account with a GDT that they are playing. This may be done automatically when a player identifies themselves with a player club card, credit card, driver's license, or other identification step. Alternatively, the player may have to provide at least one additional piece of information or identification to access a player credit account and associate it with the gaming device terminal. In embodiments where a player “checks-out” a GDT from a casino services desk, the casino operator may verify the player's identity and make the necessary association with a player credit account.

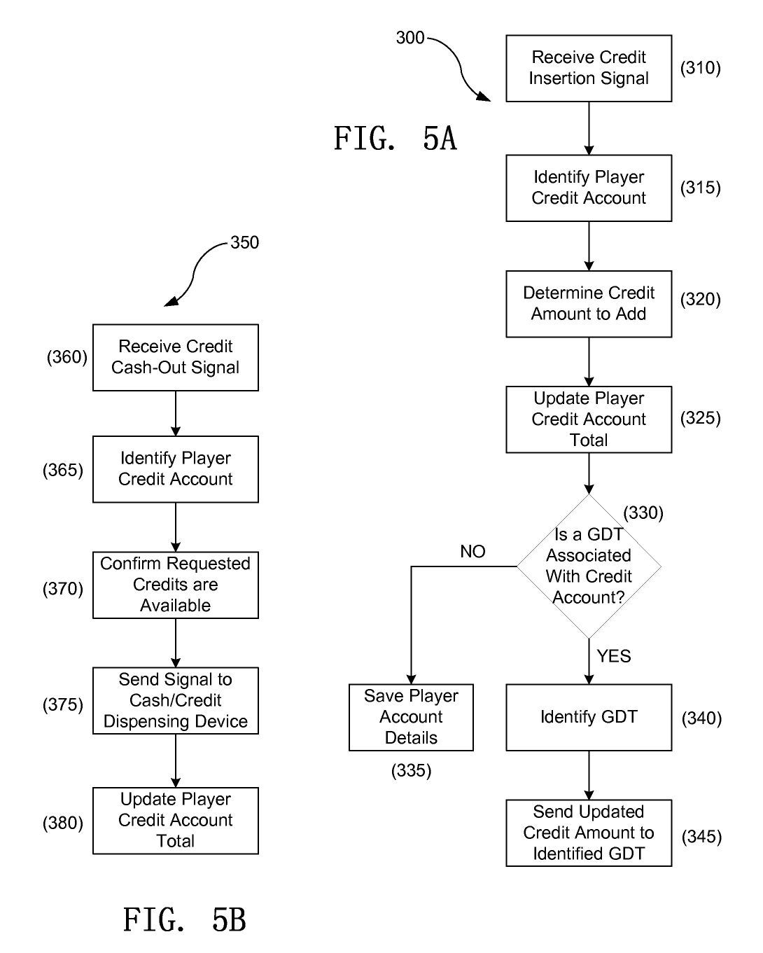

In these types of systems players may add or remove credits from their player credit accounts using various methods. For example, in some systems, one or more cash-kiosks may be placed on the gaming floor to allow a player to access his or her player credit account. That is, at the cash-kiosks, the player may add additional credits to her player credit account by inserting cash or tickets into a bill/ticket acceptor, by swiping a credit or debit card through a magnetic strip card reader, or otherwise providing information that allows money to be transferred to a specified player credit account. Additional details of this process are described below with reference to FIG. 5A. Additionally, the player may remove extra credits from her player credit account at the player kiosk by requesting cash or transferring credits to a bank account, credit card account, or other player controlled account. Additional details of this process are described below with reference to FIG. 5B. Although the above example refers to a cash-kiosk, players may also manage their player credit accounts at a casino services desk/cashier cage or at a personal computer over the Internet from home or other locations.

Server-centric systems can be embodied in many different ways with various elements of control over game play being transmitted in different manners and/or at different times. For example, in one type of server-centric system, every bit of data appearing on the gaming device is sent in substantial real time. That is, if an image of a spinning reel is to be displayed on the gaming device in response to a game initiating input, the server would transfer the animated graphic file to the gaming device terminal with instructions of which reel to show the graphic and the duration that the graphic animation should be displayed. In other types of server-centric systems, some graphic, sound, or other data files may be “pre-loaded” on the gaming device and stored in a local cache or memory on the gaming device terminal prior to game play. While all game play is still controlled by the server, the server does not need to constantly resend graphical or other data over the connection to the gaming device terminal during game play. Rather, the server merely provides instructions for displaying a certain graphic sequence and the GDT retrieves the specified graphic file from its memory and implements as instructed by the central gaming server. These systems may have the advantage of not using as much connection bandwidth as compared to the server-centric systems with real-time control since large graphic, animation, and sound files do not need to be repeatedly transferred. Although networks allow large amounts of data to be regularly transferred, casinos having many wireless GDTs in play at the same time may benefit from the decreased wireless network traffic between the GDTs and central gaming server.

In yet other embodiments, server-centric systems may be configured to incorporate existing gaming device on a casino floor. These existing gaming devices include mechanical reel spinning games, video slots, video poker games, video keno, video black jack, etc. Often times, these existing games will come with gaming cabinets with specific glass graphics, reel strips, lighting configurations, top box features, etc. that lend themselves to only one or only a few game themes. Here, server-centric systems or hybrid server-centric systems may be implemented to run only the single game or only a few related games on the existing game devices. For example, on a spinning reel Wheel of Fortune® game, the gaming device may simply receive random numbers from the central gaming server to determine game and bonus outcomes. Here the management of the spinning reels, the bonus wheel, the sounds and graphics of the game, etc. may all be controlled by the gaming device with the server only supplying the random data necessary to determine game and bonus outcomes.

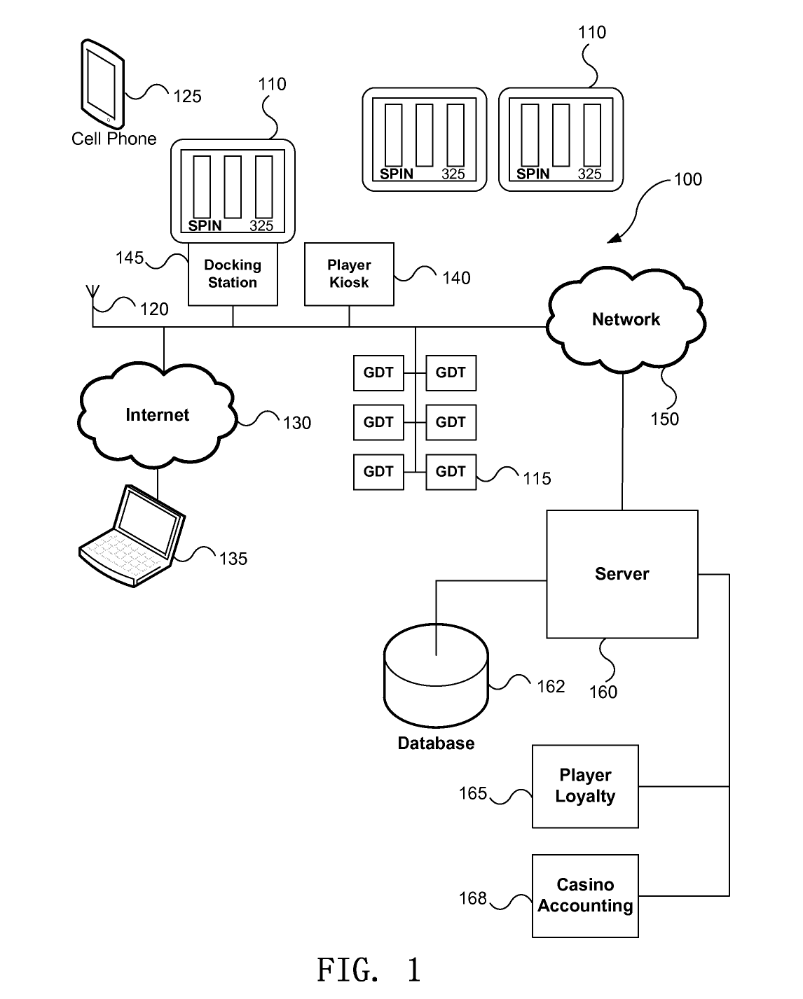

FIG. 1 is a system diagram illustrating a gaming system with a server-centric architecture according to embodiments of the invention.

Referring to FIG. 1, a sever-centric gaming system 100 includes a central gaming server 160 connected to a plurality of gaming device terminals through a network 150. Here, the gaming system 100 is configured to connect to variety of different gaming device terminals including wireless GDTs 110, cell phones 125, personal computers 135, and traditional gaming devices 115 acting as gaming device terminals. For ease of reference, gaming device terminals will be referred to in general using the reference number “110+”, which when used may be referring to any or all of the different gaming device terminals. Specific types of gaming device terminals will be referred to by their illustrated reference numerals. Here, the wireless GDTs 110 may be directly connected to the network 150 via a wireless antenna 120 or a docking station 145, or may be connected to the network 150 through the Internet 130 or another type of wireless or wired connection.

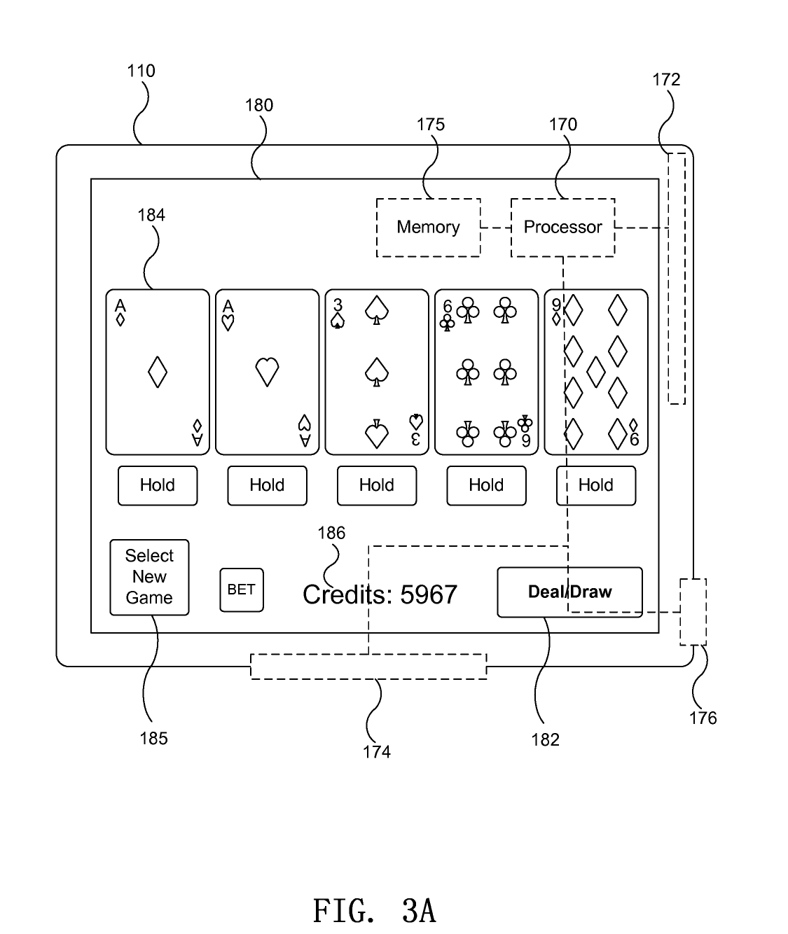

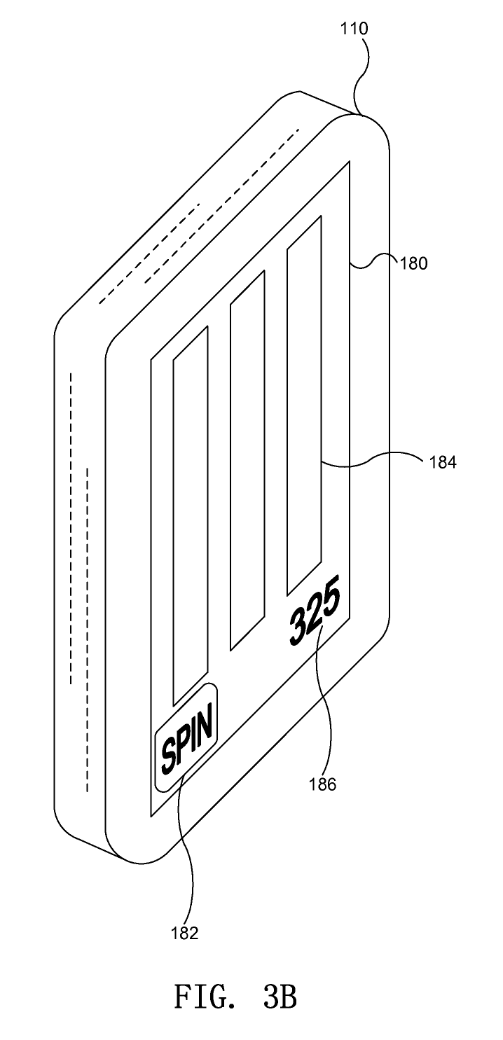

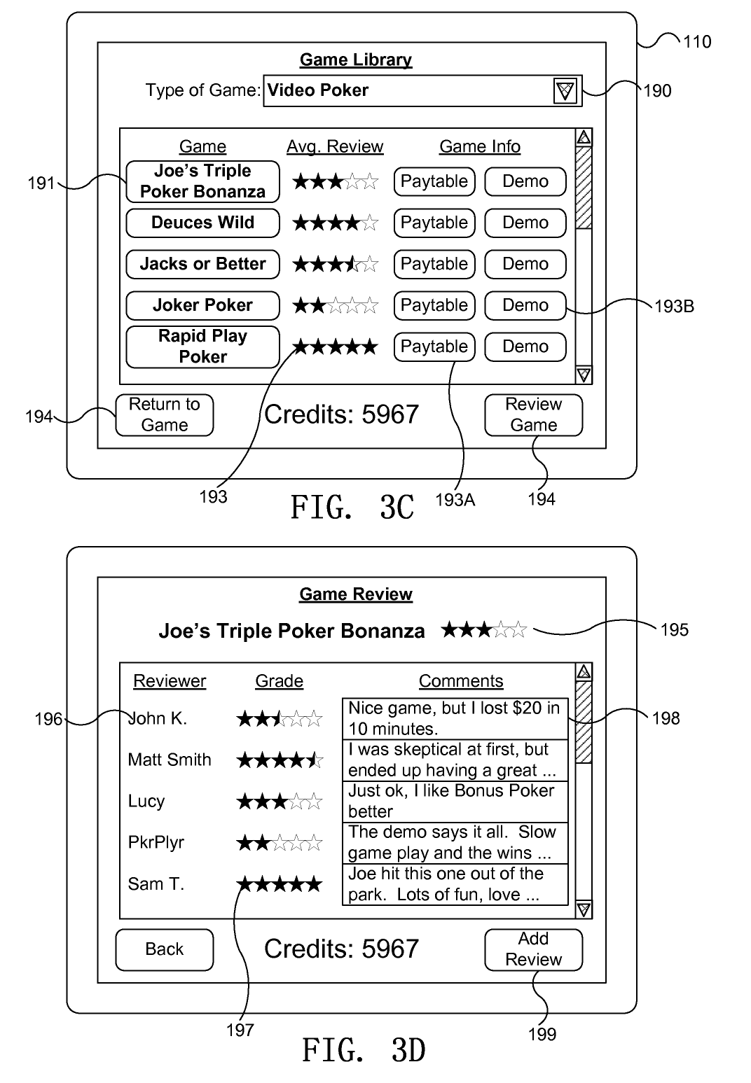

The wireless GDTs 110 may be handheld wireless computing devices configured to connect to the central gaming sever 160 and operate a plurality of game types from a library of available games. Details about wireless GDTs are discussed below with respect to FIGS. 3A and 3B. These wireless GDTs 110 may be checked out by players visiting a casino at, for example, a player assistance desk. Here, the casino may associate a unique number of the GDT with an exiting player credit account upon identification of the player so that the “checked-out” GDT can place wagers from the player credit account. In other embodiments, the wireless GDT 110 may be “preloaded” with a credit total at the casino help desk in response to a player authorizing an amount of money to be transferred to the casino (e.g., handing over cash to the casino attendant, or using a credit card to access money). During game play, the player may return to the casino help desk to add additional credits to the wireless gaming device, or the player may visit a player-kiosk (cash-kiosk) 140 connected to the gaming network 150 to add additional credits to the wireless GDT 110. The player-kiosk 140 may include a bill/ticket validator to accept additional money from the player and/or may include a magnetic strip reader for accessing information about a credit/debit card used to transfer money to the wireless GDT 110. The player-kiosk 140 may also include a ticket printer or cash dispenser where a player can redeem or “cash-out” remaining credits on their wireless GDT 110. The player-kiosk 140 may also be used to enter information needed to access a player credit account or player loyalty account. Thus, the magnetic strip reader on the player-kiosk 140 may also be able to read a player loyalty/club card, or the player-kiosk may include a biometric scanner or other device capable of identifying a player.

Wireless GDTs 110 may also be purchased by a player and personalized in some gaming system embodiments. While these embodiments do not allow the casino to keep as tight of control over the game device terminals, they may allow a player to choose a preferred color scheme, graphic layout, or configuration for a wireless gaming device terminal 110. Additionally, a player may be able to use a purchased wireless GDT 110 at multiple casinos. Each casino may have a log-in process, check-in process, or other security system set in place before a wireless GDT 110 can interface with a gaming system 100, but allowing players to own a wireless GDT 110 may reduce overhead costs of buying and maintaining many GDTs to check-out to players and eliminate lines that may form on weekends or holidays to check-out a GDT. Other models of ownership, leasing, or otherwise supplying GDTs are possible in other embodiments.

Using wireless GDTs 110 in a server-centric gaming system has several advantages. One advantage is that a player may move freely about a casino property with the GDT 110 and choose what game to play and when to play it. For example, if a player visits a casino restaurant, the player may want to gamble during the time between placing and order and receiving food. With the wireless GDT 110, a player can select a game and place wagers while waiting. A casino may place limits on where a wireless GDT may be played by limiting a wireless network range, or including a location device, such as a GPS transmitter/receiver, in the gaming device terminal. This may prevent, for instance, a player taking the GDT to a nearby restaurant outside of the casino to play. Alternatively, a casino may place very little restriction on where a GDT can be played and use cell phone networks, wireless Internet networks, or other communication networks to facilitate a connection between the wireless GDT 110 and the central gaming sever 160.

In addition to configuring existing gaming device 115 to operate on a server-centric gaming system (or implementing new gaming devices configured to operate on a server-centric gaming system) a casino may use docking stations 145 to provide players a comfortable and familiar place to engage in game play. These docking stations 145 may include a gaming cabinet housing a ticket/bill validator, ticket printer, enlarged video or mechanical game displays, top boxes, and/or chairs to provide a traditional gaming experience to a player and add functionality to the a wireless game device terminal 110. The docking stations 145 may include a connection device to connect to a docking port (See FIG. 3A) of a wireless game device terminal. The docking station may be connected to a player credit account system, player loyalty system 165, casino accounting system 168, and/or the central gaming sever 160. Alternatively, the docking station may use the wireless connection of the GDT 110 to connect to the central gaming server 160. Docking stations 145 will typically be directly connected to a building power supply. Thus, players may also use the docking stations 145 to recharge a wireless GDT 110 without interruption to game play.

A docking station differs from a fixed gaming device terminal connected to the server-centric gaming system in that game play data may be transferred though, or stored and retrieved on, the wireless GDT 110 that is docked at the docking station 145. Here, for example, docking stations not in use can be quickly and easily moved to reconfigure game floors without needing to update data connection configurations.

Docking stations 145 may be located around various locations within a casino so that players can choose a location they prefer to gamble. While some docking stations 145 may be configured to closely resemble conventional gaming devices, other docking stations may be configured to provide other styles of devices and game environments. For example, docking stations may be implemented in bar tops, tables, or wall portions. In one instance, a simple docking station with power and network connectivity may be implemented in a pool-side cocktail table so that a player can recharge a wireless GDT 110 while taking a quick swim, quickly download a news paper to read or TV show to watch while enjoying the sun, make reservations at a casino restaurant, and then play fifty games of video poker.

Additionally, in player-owned GDT models, docking stations 145 may provide a mechanism by which a player can validate their GDT 110, add credits to their GDT, charge their GDT, allow play with mechanical reels or a common video display, or simply provide a comfortable area to play their GDT.

Wireless gaming device terminals 110 may also provide unique and flexible arrangements for competitive or cooperative linked gaming. For example, a casino may provide an area with several couches or chairs that allow a group of players to interact with each other while playing a linked game. A common video display may be mounted nearby to show a player score chart, common game play or bonus screens, or other common game information. A linked connection screen may be implemented on the GDTs 110 to allow players to connect to one another, or connected docking stations 145 may be used to link the GDTs.

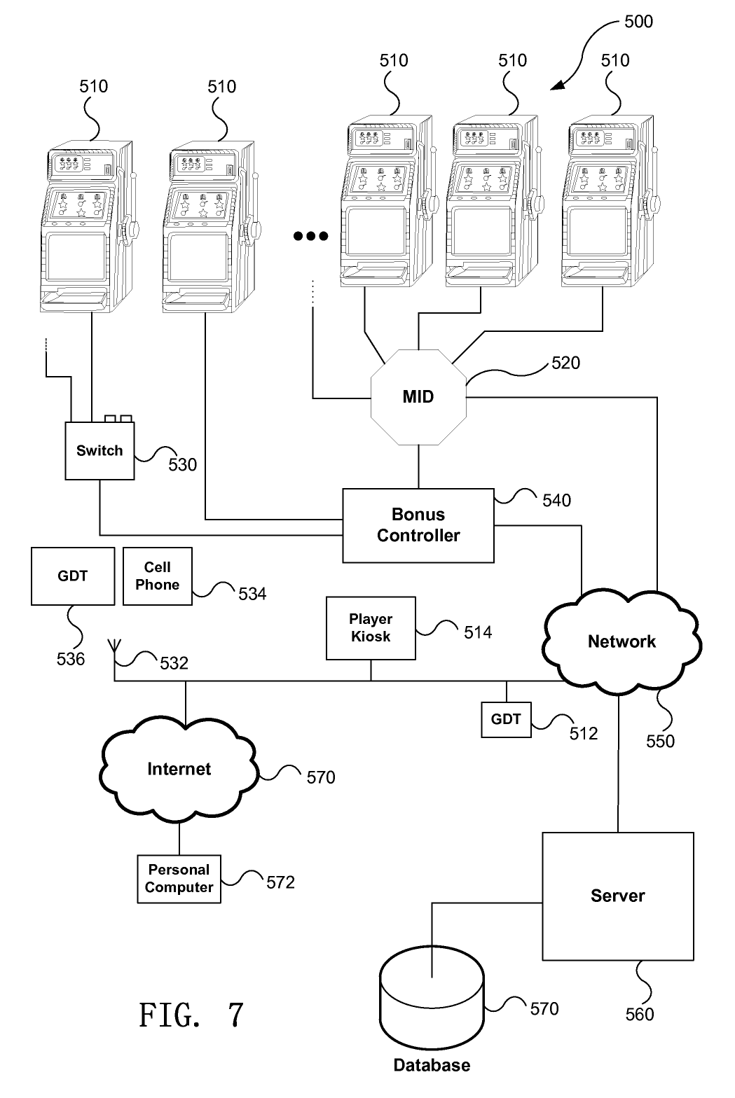

Although wireless GDTs 110 provide many flexible gaming options, existing gaming devices 115 may be used as gaming terminals in a server-centric gaming system 100 as well. Use of existing game devices 115 in a server-centric gaming system 100 may provide players with a familiar gaming experience while availing them to the advantages of the server-centric model, such as a broad library of games, player credit account flexibility, and customizable game play. Depending on the system setup desired by the casino, the existing game devices 115 may appear to play exactly the same as a stand-alone game device to players, or may provide one or more features available because of the server-centric connection to the player. Details about connecting existing gaming devices to a server-centric system 100 are discussed below with reference to FIGS. 7-10.

The central gaming server 160 may be connected to a database 170, as well as a player club/loyalty system 162 and/or a casino accounting system 165. Additionally, although not shown in FIG. 1, the CGS 160 may be connected to a separate credit account system that manages player credit accounts. In some embodiments, the database 170 may store player credit account information. Here, the central gaming server 160 may also help manage credit transactions between the database 170 and the gaming device terminals 110+.

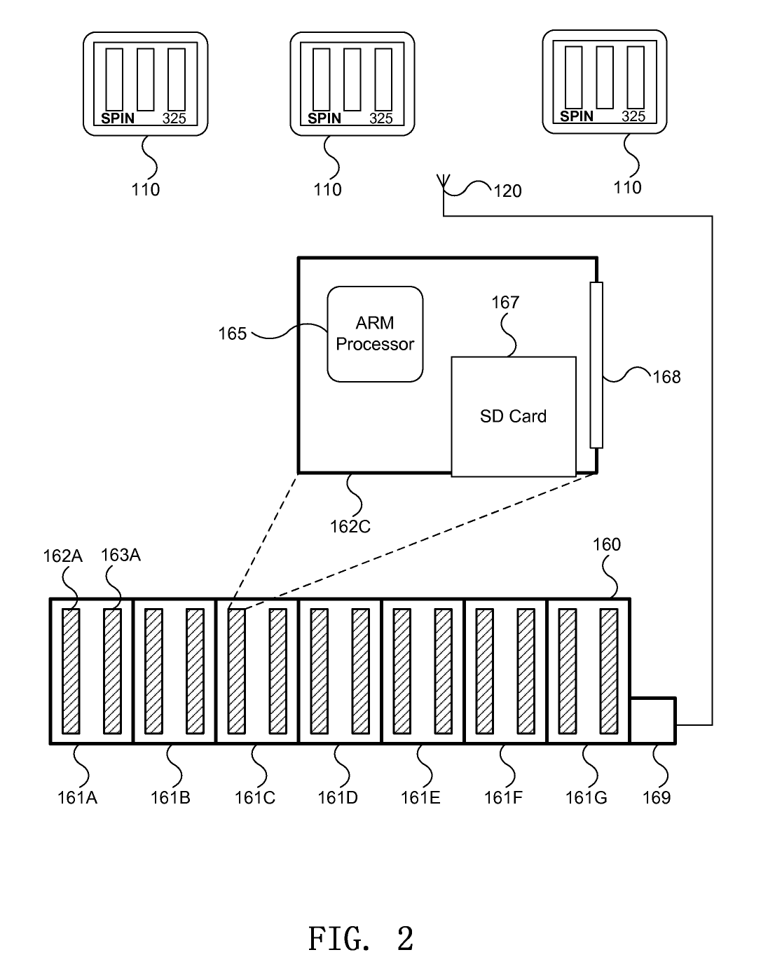

The central gaming server 160 may be implemented on variety of computing devices or systems in various embodiments depending on the scope and requirements of the server-centric gaming system. For example, in basic systems, the CGS 160 may include only a single computing device with a processor and memory storage; while in more complex gaming systems, the CGS may include multiple server racks with powerful multi-core processors and associated memory storage hardware. One example of an efficient server option, which is configured as a central gaming server, is described below with reference to FIG. 2.

FIG. 2 is a detail diagram of a server in the gaming system illustrated in FIG. 1 according to embodiments of the invention.

Referring to FIG. 2, a detailed example of central gaming server 160 is illustrated. Here, the CGS 160 includes multiple processors 161A-161G each having two processor cards 162A-162G, 163A-163G. For example, processor 161A has a first processor card 162A and second redundant processor card 163A. Each processor card (shown in the detailed view of processor card 162C) include an ARM processor 165, a memory 167, and a communication port 168. The memory 167 may be a SD memory card that uses flash memory. The combination of an ARM processor 165 and an SD memory card mean that each processor card 162, 163 has no moving parts and no disk. This greatly simplifies each processor card and makes mishaps and errors due to mechanical failure more remote. In addition, since the second processor card 163 in each processor 161 is a redundant copy of the first processor card 162, additional protection against errors and failures is introduced. The processor cards 162, 163 are “hot-swappable,” meaning that they can be removed and replaced without resetting or reloading the entire system. Thus, if one processor card is malfunctioning, or a new software (or game) update is to be implemented, one of the processor cards in processor 161 can be removed and repaired/updated as needed. When the processor card is replaced, the ARM processor and memory may be synched with the other processor card so that the cards are again completely redundant. Each processor may communicate with other processors or the system though an Ethernet connection and associated communication protocol.

Although a central gaming server can be implemented on any type of server system, the above described server system has several advantages over a more conventional blade type server rack. These advantages include a smaller footprint, less required maintenance, additional reliability, no moving parts, Ethernet communication speeds and ease, and the ability to be hot swappable. These advantages translate to less downtime for server, which is important in keeping games running smoothly in a server-centric gaming system.

In this illustrated embodiment, the central gaming sever 160 is connected to a plurality of wireless gaming device terminals 110 through communication port 169 coupled to a wireless transceiver 120. The communication port 169 may generally connect the server 160 to a gaming network 150 (FIG. 1) and hence to the various other gaming device terminals, player kiosks, or other gaming system components.

FIG. 3A is a detail diagram of a gaming device terminal in the gaming system illustrated in FIG. 1 according to embodiments of the invention.

Referring to FIG. 3A, an example gaming device terminal 110 is implemented on a handheld wireless tablet, such as an iPad® or similar touchscreen modular device that can wirelessly connect to a gaming network. Here, the GDT 110 includes a game display 180 showing a plurality of game indicia 184, one or more game buttons 182 related to game play of a selected game, a credit meter 186 associated with a player credit account, and a game library button 185 that takes a player to a game library screen (such as the one shown in FIG. 3C). In addition, the GDT 110 includes a local processor 190, a memory 195 connected to the processer, a wireless antenna 192, a communication port 196, and a docking port 194.

The memory 195 is connected to the local processor 190 and may be configured to store various game information about game play, such as downloaded game graphics or sounds or player identification information used to access a player loyalty account or player credit account. This memory may be volatile (e.g., RAM), non-volatile (e.g., flash memory), or include both types of memory. The wireless antenna 192 may be connected to the processor 190 and be used to communicate with a wireless transceiver or antenna 120 (FIG. 1) coupled to a gaming network 150. The wireless antenna may be configured to receive any of a number of types of wireless communication signals, or may be configured to only receive a casino specific (or encrypted) signal.

The communication port 196 is also connected to the local processor 190. In some embodiments, this communication port 196 may be a universal serial bus (USB) port that allows a player to upload player information or preferences, or download game session statistics or other information. The USB port may be used to connect the GDT to a personal computer or to a player thumb flash drive. In other embodiments, the connection port 196 may be structured as a serial port, parallel port, Ethernet port, optical connection, a second wireless antenna, or any other type of communication port used to transmit and receive data. Although only one connection port 196 is shown in FIG. 3A, the gaming device terminal 110 may include multiple communication ports. As described below, in many existing gaming devices, this connection port 194 is a serial connection port utilizing a SAS protocol to communicate to one or more remote game servers, such as player tracking servers, bonus servers, accounting servers, etc.

The docking port 194 may be used to connect the GDT to a stationary game station for enhanced game play. For example, as mentioned above, a game station may include a larger game display, a ticket/bill acceptor, a ticket printer, a comfortable chair, physical game buttons, faster connection speeds, or other features that make the gaming experience easier and/or more enjoyable. The docking station may also allow a battery in the GDT 110 to recharge. The docking port 194 or the communication port 196 may be used with a card swipe attachment, biometric reader, or other device capable of identifying a player to access a player loyalty account and/or a player credit account. Alternatively, other embodiments of a GDT 110 may not include one or both of the communication port 196 and docking port 194.

FIG. 3B is a perspective view of a wireless gaming device terminal according to embodiments of the invention.

Referring to FIG. 3B, a wireless gaming device terminal 110 includes a touchscreen game display 180 showing a plurality of game indicia 184, a credit meter 186, and one or more game buttons 182. In the GDT 110 illustrated in FIG. 3B, all player inputs to the gaming device terminal are made though the game display 180. However, as discussed above, one or more mechanical player input devices may be present on other GDT embodiments. Here, the game indicia 184 includes three video reels that may be spun to show a game outcome. The credit meter 186 may be touched to bring up information about the associated player credit account, and the spin button may be pressed to initiate a gaming event on the GDT 110. Additional game buttons (not shown) may be present to bring up a library of games, change a wager amount, get information or help on a game, etc. Alternatively, various “touch-movements” on the game display 180 may bring up different screens. For example, a sliding motion along the bottom of the game display may bring up a game library screen (such as the one shown in FIG. 3C), a pinching touch motion over the credit meter 186 may bring up a wager amount screen, and a vertical swiping motion over the game indicia may bring up a game help screen. Many more possible motion and screen possibilities exist, which may be implemented in other embodiments.

As mentioned above, one advantage of a server-centric gaming system is the ease of providing a large number of games to a player at a single gaming device terminal. Another advantage is added flexibility in displaying information about the games so that the player can decide if a new game (or different game) looks and sounds appealing. Without the need to completely download all of the game code needed to operate a game, a player is able to quickly try multiple different games and then spend more time with a game that they enjoy. However, providing an interface and system to allow a player to easily navigate a large game library may make game browsing and selection easy and informative.

FIGS. 3C and 3D show various game play screens controlled by a central gaming server. FIG. 3C is a detail diagram of a display of a gaming device terminal showing an exemplary game library screen according to embodiments of the invention. FIG. 3D is a detail diagram of a display of a gaming device terminal showing an exemplary game review screen according to embodiments of the invention.

Referring to FIG. 3C, a game library screen is shown on a game display of a GDT 110. Players may access such a screen by pressing a game library button or using another type of player input to request the game library screen. Game library screens may be configured in many different ways. The example game library screen illustrated in FIG. 3C includes a game type drop-down menu 190, and a list of selectable games corresponding to a selection made in the drop-down menu 190. Each listed game includes a game select button 191, a game review section 193, a paytable/game info button 193A, and a demo button 193B. Here, a player may press the game select button 191 on a desired game to select the game to play. When a game is selected, the central gaming server will download an initial game screen for the selected game and allow the player to place wagers and initiate gaming events. A player may press the game review section 193 associated with any game to bring up a game review screen, such as the one shown in FIG. 3D and described below. The paytable/help button 193A may be pressed for a game to show information regarding the associated game. This game information may include paytables for winning base game symbol combinations, information on bonus play, etc. The demo button 193B may be pressed to view a short demo of the game. The demo may include a video of example game play occurring on the associated game or a series of pictures of various game play scenarios that could occur on the associated game. The demo may give a player a feel for the graphics, sounds, and speed of game play for an associated game. Additionally, the demo may include examples of bonuses or any unique game features that may intrigue or inform the player. The game display may also include one or more game buttons 194, such as a back (or return to game) button to return a player to previous game that they were playing and/or a game review button to review the game the player was previously playing.

In the example illustrated in FIG. 3C, a player has selected video poker games from the game type drop-down menu 190. A list of video poker games then appears on the screen with a scroll bar to allow the player to scroll down the library of video poker games. The player may be able to touch any of the headings to sort the list of games. For example, the player may touch the “Game” heading to sort the list of games alphabetically or touch the heading “Avg. Review” to sort the list of games by rating. A default listing of games may be ordered by newness of a game or by game popularity. If the player selects a different game type from the drop-down menu 190, a corresponding list of games will appear on the game display.

Referring to FIGS. 3C and 3D, a player has touched the game review section 193 next to the game “Joe's Triple Poker Bonanza” to bring up the game review screen shown in FIG. 3D. Here, the game review screen shows the average rating 195 of the game, which in this case is three stars, along with individual ratings and review comments. Each entry includes a reviewer identification 196, a grade or rating 197, and a comment section 198. The reviewer identification 196 may include an identified player's name or may include a player's alias, casino name, or player avatar. The rating section 197 reflects the rating given to the game by the identified reviewer. The comment section 198 may be filled in by the reviewing player and allows the reviewing player to add comments or qualifications about their rating or experience with the game. A truncated or brief section of the comments may be visible on the review list, but may be touched by a player to reveal the full comment. For example, a player may touch the comment section 198 associated with reviewer “Matt Smith” to read more about Matt's review. The game display may also include one or more game buttons 199, such as a back (or return to game) button to return a player to previous game that they were playing and/or a game review button to review the game on the game review screen.

Game reviews and comments may be particularly helpful for players that are looking for new games to try, or new players that are looking for a good first game. The reviews may also be helpful in game systems where various game designers can develop new games that are implemented on the central gaming server. This way, new or unusual games may get noticed and, with good reviews, played often. As independent game developers may be paid a percentage of the coin-in on a developed game, or a small fee per play, getting noticed with positive reviews may be highly desirable.

Players may also publish their accomplishments to friends via email, text messages or social networks such as Twitter or Face Book. Here a player can configure their account to send a message such as “I am at the casino, come join me” or “I am at the casino, watch me play” to selected friends and associates. This message is automatically sent whenever the player begins play at a casino. Updates are automatically sent whenever a jackpot or other notable event, occurs. The messages may include special offers from the casino to induce the associates to visit.

In another embodiment, players may compose messages at the game, such as “I'm going to dinner, please join me”, or other communications with family, friends and/or Twitter followers. Further, players may receive emails, texts and/or social network messages while at the gaming machine. This is especially useful to help two players within the casino coordinate their activities. For example, a husband and wife may have different gaming preferences, but want to share meals or entertainment events. Here, the husband may be playing at a high stakes video poker machine near the sports book while the wife prefers video penny slots in a spot that overlooks the pool. While playing his video poker machine, the husband may, for instance, send a message to his wife inquiring if she would like to meet for lunch at one of the casino's restaurants.

In another embodiment, the casino or gaming venue may have a limited number of licenses that govern the total number of games they may offer. The server-centric system is configured to know that limit and not exceed it. However, the server-centric system could support the placement of more gaming device terminals around the casino than there are licenses. This may provide more options to the players while automatically maintaining the limits set out in the license. For example, players could choose what location to gamble in and log in to a gaming device terminal to begin play. They server-centric system could monitor and limit the number of simultaneous users to meet the licensing requirements while still configuring the casino floor with game terminals at convenient locations.

In another example, some locations are allowed only a limited number of gambling devices, 15 for example, Often, all 15 of these devices are installed within a bar because of the physical bulk of gaming devices. During busy times, however, people may be sitting at the bar and not playing any of the gaming devices. If other patrons would like to play the gaming devices, they have to wait for someone to leave the bar. Effectively, the non-playing patrons at the bar are blocking access to the gaming devices and the location is not getting full use out of its 15 game license.

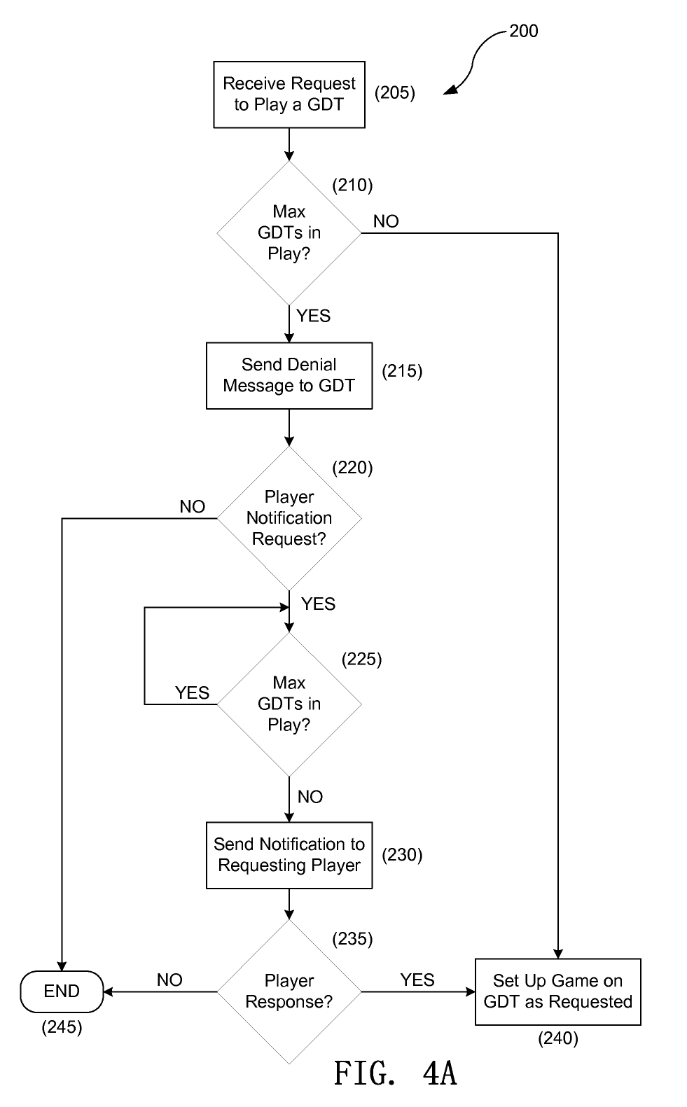

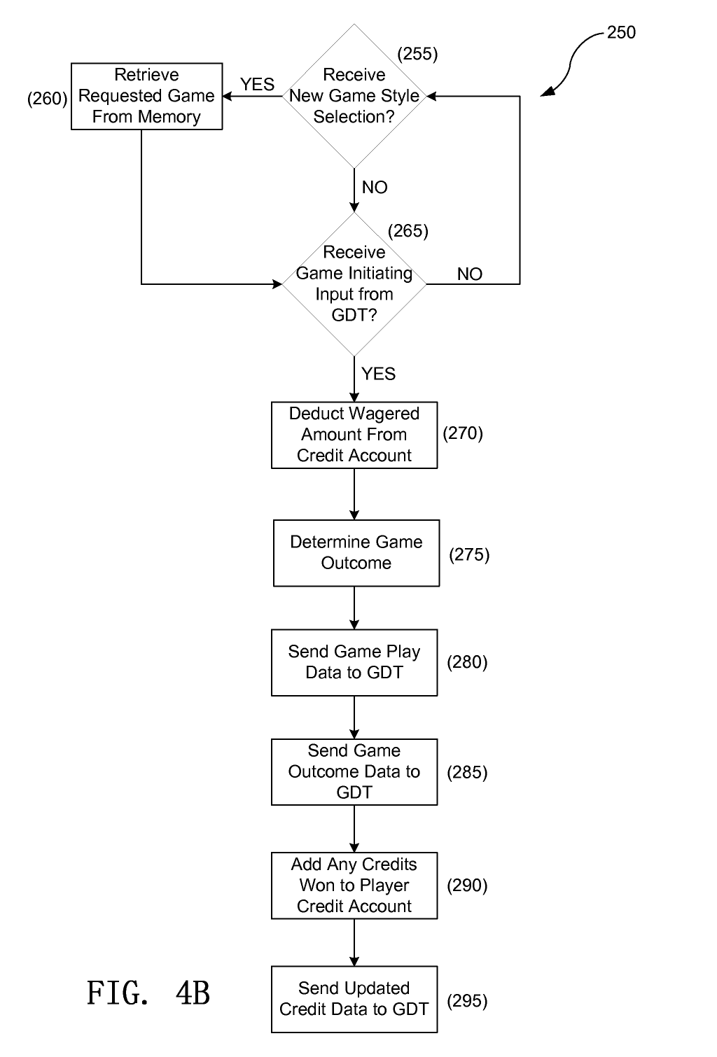

With a server-centric system, other game device terminals could be installed in tables or in other areas, or provided as mobile devices. Thus, a location might choose to have 30 game device terminals positioned around their area even though they have only a license for 15 game devices. Half of these game device terminals may still be installed in the bar, but 10 more may be positioned at various tables around the bar, and 5 GDTs may maintained on mobile tablet-styled terminals that can be checked out by patrons. Because the server-centric system allows only 15 gaming devices to be active simultaneously, players have more choices of where to play while the location stays within its licensed capacity. For example, if 15 of the gaming device terminals are currently being played, the central game server may put a locked-screen up on the other 15 GDTs. Once a player on one of the played 15 GDTs cashes-out, checks back in a mobile GDT, or has zero credits on the credit meter for predetermined time the CGS may remove all of the locked-screens on the other 15 GDTs until another one is put into play. Hence, the use of the server-centric system may optimize the use of gaming devices in locations that have a license specifying a maximum number of active game devices. One method of operating a server-centric gaming system to determine availability of a gaming device terminal is shown in FIG. 4A.

Referring to FIG. 4A, flow 200 begins when a request to play a game device terminal is received in process 205. The CGS then determines if a maximum number of gaming device terminals (such as the maximum number of active gaming devices allowed by a license) are in play in process 210. If the maximum number of GDTs are not currently in play, flow 200 proceeds to process 240 and the game is set up as requested on the GDT in process 240. A more detailed example of how process 240 may be carried out is discussed below with reference to FIG. 4B. If a casino or gaming location has less than (or the same number as) a maximum number of allowed gaming devices under a license, flow 200 could simply skip process 210 and move directly from process 205 to process 240. The central gaming server may be configured to detect how many GDTs are present and operational and automatically skip from process 205 to process 240 when the number of detected game device terminals does not exceed an entered max license value. Alternatively, in a casino that has less than a maximum number of allowable game devices, or that is not subject to a maximum number license, a central game server may be configured to bypass flow 200 entirely and simply follow the method of operation shown in FIG. 4B. This configuration may be set by a casino operator or by the manufacturer of the gaming system.

If it is determined that a maximum number of gaming devices are in play in process 210, flow 200 proceeds to process 215 where a denial message is sent to the requesting game device terminal. The denial message may explain that a maximum number of game devices are presently in use, or may simply state that game play on the GDT is currently unavailable. In some embodiments, the denial message may include the option of allowing the player to be notified as soon as the game device terminal is available for play (i.e., someone else ceases play on another GDT). This may be useful for example if a player is doing something else while waiting to game, such as dining or ordering a drink. Also, in establishments with a large number of game devices, the rate of turnover may be high enough to ensure a minimal wait.

Here, process 220 is used to determine if the player has requested a notification be sent once the game device terminal is available to play. If the player chooses not to have a notification sent or if this notification feature is not available, flow 200 ends at process 245 where it waits to receive another request to play a GDT.

However, if the player chooses to be notified when the gaming device becomes available in process 220, flow 200 proceeds to process 225 where the central gaming server continues to check if the maximum number of GDTs are being played. As discussed above, the CGS may determine that a game device terminal is not being played anymore when a player cashes out, when the value on the credit meter is zero (or a small value) for a predefined amount of time, when a player checks a GDT back into to a casino service desk, or by other indicators that the GDT is no longer being played. When the central gaming server determines that the game device terminal is available to play, it sends a notification message to the requesting player in process 230. This notification may be a text message, automated phone call to a player cell phone, or message appearing on the GDT. In some embodiments, the central game server may ask requesting GDTs whether they would like to join prior to unlocking other GDTs for play. If there are two or more players waiting, a queue may be set up where the first requesting player is asked first if they want to join, followed by a subsequently requesting player, etc.

In process 235, the central gaming server determines if the player has responded. The player may have a set time limit to respond before the CGS unlocks all GDTs or asks a second waiting player if they are ready to join. If the player responds that they are no longer interested in playing, or they do not respond within the predefined time limit, flow 200 ends at process 245 where it may take any of the above steps discussed above. If the player is still waiting to play the GDT and responds to the notification, flow 200 proceeds to process 240 to set up the game as requested by the player as discussed above.

FIG. 4B is a flow diagram of a method of operating a gaming system during game play according to embodiments of the invention.

Referring to FIG. 4B, flow 250 begins with process 255, where the central game server determines whether a new game style selection has been received. If a request for a new game style has been received, flow 250 proceeds to process 260 to retrieve the requested game from memory. As discussed above, the game server may include a library of games that are available for a player to select and play. A list of the available games in the library of games may be stored in the memory of a game device terminal, or may be downloaded to the game device terminal from the central game server upon request from a player. That is, a player may touch a button or otherwise make one or more inputs to request the list of available games on the game server. In response to this request, the game server sends over a list of the currently available games to the game device terminal that has issued the request. This list may include a simple description of each available game, or may include a short demo of the game, rules and/or paytables for each game, and reviews of the game from other players.

After a new game has been retrieved from memory, or if a new game style selection has not been received, flow 250 proceeds to process 265 to determine if a game initiating input has been received from the gaming device terminal. That is, if a player input is received at a central game server, the game server determines if the received input is a request for a new game style (process 255), if the received input is a game initiating input (process 265), or another type of player input. In it is determined that a game initiating input has not been received, flow 250 returns to process 255 to wait until another input is received. Although not shown in flow 250, other processes may be carried out by the central game server or other game system components when the received input is not a new game style selection or game initiating input. For example, a player may be changing an amount of a default wager, checking her player club points, or some other action not related to a new game style selection or a game initiation.

If it is determined that a game initiating input has been received from a gaming device terminal in process 265, flow 250 proceeds to process 270 where a wagered amount is deducted from a player credit account. For example, if a player is playing a five reel slot game with 20 lines played at two credits per line in a nickel denomination, a wager amount of 40 credits or $2.00 will be deducted from the player credit account associated with the gaming device terminal at which the player is playing. A game outcome is then determined in process 275 for the game. In the above example, the game outcome may include a determination of where to stop each of the five reels and a determination of whether any symbol combinations appear on the played pay lines or game screen that are associated with an award (e.g., winning outcomes).

Prior to displaying the determined game outcome, the central game server sends and controls game play data to the gaming device terminal in process 280 so that the actual game play is presented to the player on the display of the GDT. While some of the graphics used in the game display may be previously loaded to the GDT and stored in the cache or memory of the GDT for use in game events, all control of the data used in the gaming event is controlled by the central gaming server. For example, in a slot machine game being played on a gaming device terminal, the background display image, generic reel spin graphics, and game play sound files may be previously loaded on the GDT for use during a gaming event, but graphics showing a game outcome, changes in the credit meter graphics, and any game event-specific data used during a game event may be transferred and controlled by the central gaming server. Additionally, the graphics and data files previously sent and stored in the cache of the gaming device terminal may be used during game play according to instructions sent by the central gaming server during the course of game play.

Game outcome data is then sent to the gaming device terminal in process 285 so that the game outcome can be displayed at the GDT. In some embodiments, the game outcome data may be sent at substantially the same time as the game play data in process 280. This data may be transferred in a packetized format to be run on the processor of the gaming device terminal, or may be transferred in substantial real-time to the GDT so that the display of the GDT is directly controlled by the central gaming server. If the gaming outcome is a winning game outcome, the central gaming server may also provide celebratory sounds or graphics to the GDT in some embodiments. In other embodiments, the CGS may simply instruct that specific celebratory sounds or graphics from a package of game data stored in local memory on the GDT be loaded and played with the game outcome.

If any prizes are associated with the determined game play, such as credit awards for a winning symbol combination appearing on a played payline, they are awarded after the game outcome has been displayed to the player. For example, credits won as a result of the game outcome may be added to the credits available to the player. In process 290, the central gaming server causes any credits won from the game outcome to be added to the associated player credit account. Here, for instance, the central gaming server may transmit a signal to player account server with instructions to add a specific number of credits to an identified player credit account. Thereafter, the updated credit data is send to the gaming device terminal in process 295 to reflect the current number credits available to the player for wagering. This updated credit data may be sent to the gaming device terminal by either the central gaming server or the player credit account server depending upon the system implementation.

Note that although flow 250 shows various processes occurring in a particular order for operating a gaming system during game play, these processes may be carried out in a different order. For example, process 275, where a game outcome is determined, may occur after game play data has been sent to the GDT in process 280. In addition, other embodiments of operating a gaming system during game play may include more or fewer processes.

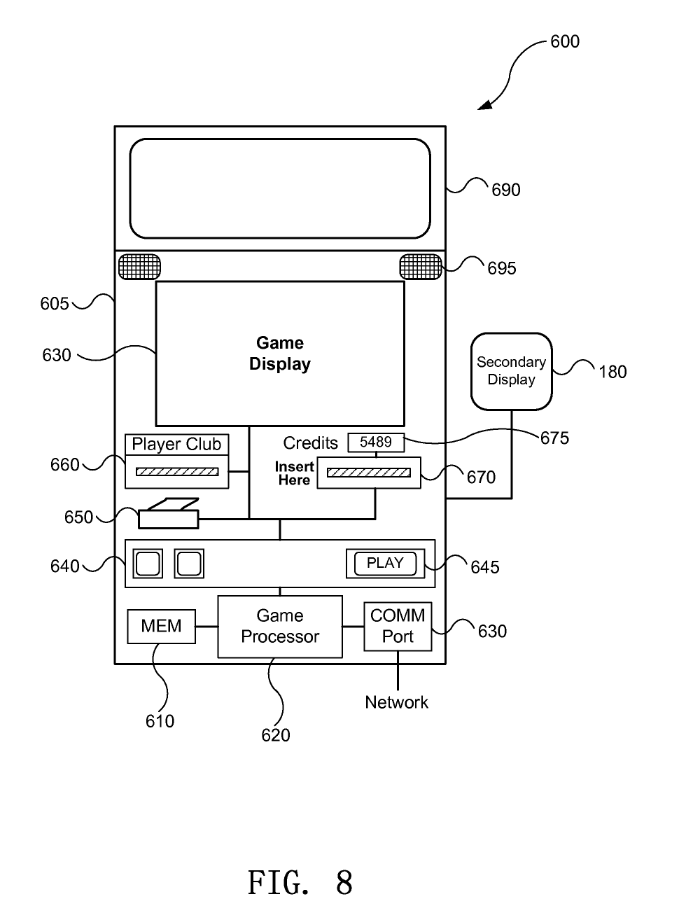

To facilitate game play on the gaming device terminals, methods of handling money or credits for wagering also needs to be implemented. With the first developed slot machines, coins were simply inputted via a slot and held in a coin hopper until a win occurred, at which time some of the coins in the coin hopper were released into a coin tray accessible to the player. Many developments have been made to how money is managed since these original slot machines. Today, most gaming devices do not accept coins at all, but rather accept various monetary bills or printed ticket credit vouchers and issue only printed ticket credit vouchers that can be cashed in at a casino cage or cash kiosk. These systems work well since most game devices have more than enough room to accommodate a bill/ticket validator and ticket printer. FIG. 8 below describes such features on a gaming device in more detail. However, for some portable gaming device terminals, such as the one shown in FIG. 3B, there simply is not space to attach such a validator and printer. Thus, as described above, the establishment of a player credit account or another type of electronic fund management system may be needed to make wagering on these portable gaming device terminals relatively easy for a player. With the establishment of a player credit account, various methods are needed to input credits into this account and remove excess credits from the account. Example embodiments of such methods are described below with reference to FIGS. 5A and 5B.

FIG. 5A is a flow diagram of a method of inputting credits into a player credit account in a gaming system according to embodiments of the invention.

Referring to FIG. 5A, flow 300 begins when a credit insertion signal is received in process 310. The credit insertion signal may be transmitted by a player kiosk where a player has inserted credits, transmitted by a casino operator who has received money from a player, transmitted from personal computer of a player, or transmitted from a game device that has a connected credit receiving device.

After the credit insertion signal is received, flow 300 continues to process 315 where a player credit account associated with the credit insertion is identified. If an identified player is already associated with the device from which the credit insertion signal was received, an indication of the player's identity may be received along with the credit insertion signal. In such an embodiment, process 315 may simply locate a player credit account based on the received player identification information. For example, if the player had previously identified himself to the credit receiving device with a player loyalty card, that player card number may be used to determine a player credit account associated with the player. If player identification information is not received with, or shortly after, the credit insertion signal, the server may prompt the player to enter at least one item of data to identify the player. This data item may be a player loyalty card, a PIN, a credit card, a driver's license, a biometric reading, a login and password, or any other type of information that could positively identify the player. This information may be retrieved by use of a card scanner, number pad, keyboard, biometric scanner, or the like. Once a player's identification is confirmed, the player credit account associated with the player can be located and identified in a database or other storage medium. In some embodiments where the player credit account is already identified, such as when the account is already associated with a gaming device terminal and the credit insertion signal is received from the GDT, process 315 may simply be omitted.

The amount of credits to add to the identified player credit account is then determined in process 320. The credit total to add may be sent with the credit insertion signal when credits are inserted into a credit receiving device. Alternatively, data including the credit total may not be sent until after the player has indicated that they have finished inputting credits at that time. The identified player credit account is then updated to reflect the new credit addition in process 325. For example, if the identified player credit account showed an initial balance of $450.00 and a $100 bill was inserted into a credit receiving device, the player credit account would be updated to reflect a total of $550 that would be available for placing wagers.

In process 330, it is determined whether a game device terminal is presently associated with the player credit account. For example, if the player had checked out a touch-screen GDT, the player's credit account may be linked to the GDT at the time of check out so that credits could be wagered and won during gaming sessions on the GDT. In another example, a player may simply insert credits into a cash terminal or kiosk to add credits to their player credit account without the credit account being associated with a GDT. If it is determined in process 330 that a GDT is not associated with the identified player credit account, flow 300 proceeds to process 335 where the new credit amount and any other new details about the player credit account are saved. If it is determined in process 330 that a GDT is associated with the identified player credit account, flow 300 proceeds to process 340 where the gaming device terminal is identified. After the gaming device terminal has been identified, the updated credit amount in the player credit account is sent to the identified GDT so that the player can immediately use the newly inserted credits in various wagers.

FIG. 5B is a flow diagram of a method of removing credits from a player credit account in a gaming system according to embodiments of the invention.

Referring to FIG. 5B, flow 350 begins when a credit cash-out or removal signal is received in process 360. The credit cash-out or removal signal may be transmitted by a player kiosk where a player has requested the dispersion of credits, transmitted by a casino operator who has received a cash-out request from a player, transmitted from personal computer of a player, or transmitted from a game device that has a connected credit printing device, such as a ticket printer.

After the credit removal signal is received, flow 350 continues to process 365 where a player credit account associated with the credit removal request is identified. This may be a similar process to that of process 315 described above with reference to FIG. 5A. That is, if an identified player is already associated with the device from which the credit removal signal was received, an indication of the player's identity may be received along with the credit removal signal. In such an embodiment, process 365 may simply locate a player credit account based on the received player identification information. For example, if the player had previously identified himself to the credit redemption device with a player loyalty card, that player card number may be used to determine a player credit account associated with the player. If player identification information is not received with, or shortly after, the credit removal signal, the server may prompt the player to enter at least one item of data to identify the player. This data item may be a player loyalty card, a PIN, a credit card, a driver's license, a biometric reading, a login and password, or any other type of information that could positively identify the player.

This information may be retrieved by use of a card scanner, number pad, keyboard, biometric scanner, or the like. Once a player's identification is confirmed, the player credit account associated with the player can be located and identified in a database or other storage medium. Additionally, the amount of available credits (credit balance) in the identified player credit account may be sent to the credit redemption device if not already displayed on a game device terminal so that the player knows how much money they can cash-out. In some embodiments where the player credit account is already identified, such as when the account is already associated with a gaming device terminal and the credit removal signal is received from the GDT, process 365 may simply be omitted.

The amount of credits to redeem from the identified player credit account is then confirmed as being available from the identified player credit account in process 370. For example, if a redemption request of $100 is received for an indentified player credit account that only has $65, the request for the $100 may be denied and the player may be asked to enter a new request amount that is less than or equal to the amount available in the player credit account. After it has been confirmed that the amount of credits requested are available, a signal is sent to the cash or credit dispensing device to issue the requested amount in process 375. Here, if the request is received from a cash kiosk or casino cashier cage, cash may be issued to the player. If the request is received from a GDT or other gaming device with a ticket printer, a credit ticket or voucher may be printed that can be redeemed for cash at a casino cashier or ticket redemption kiosk. If the request is made from a device that is connected to a player account associated with a credit card, a credit deposit may be made on the associated credit card. Thereafter, the total in the player credit account is updated in process 380 to reflect the redemption of some or all of the credit in the player credit account.

As discussed above, is the server 160 (FIG. 2) includes flash memory or SD cards using flash memory 167, the memory may be specifically configured to prevent memory wear on certain portions of the memory. Memory wear occurs when certain cells or transistors in the memory fail due to repeated erasing and re-programming. Most flash memory products can withstand at least 100,000 program-erase (P/E) cycles, and some newer flash memory products guarantee at least ten times that many P/E cycles. However, if a certain portion or block of memory is set up to store certain data values that change frequently during the course of a game session, such as game outcome data, credit account data, etc. these P/E cycle limitations of the flash memory can quickly become an issue. One solution is to simply replace the memory cards at certain time intervals to prevent memory errors. However, even though the price of memory has fallen drastically in recent years, this replacement methodology could become expensive.

Another solution is to implement one or more wear-leveling techniques to spread the programming and erasing operations over a greater section of the memory instead of centered on one section of cells or transistors. These wear-leveling processes may be programmed into the memory chip firmware, or implemented in the file system drivers of the processor or memory controller. One method of wear-leveling is to dynamically remap blocks of the memory to new locations to spread the write (program) operations between memory sectors. This method is especially useful if a large volume of data is being repeatedly written to one memory location. However, when small amounts of data are being more frequently written, such as game outcome data or credit account data, this technique loses some of its elegance because the data being written doesn't typically take up an entire memory block. Additionally, when flash memory is erased, a block of memory cells is erased at once. Thus, although individual cells or transistors can be programmed, they cannot be erased by themselves.

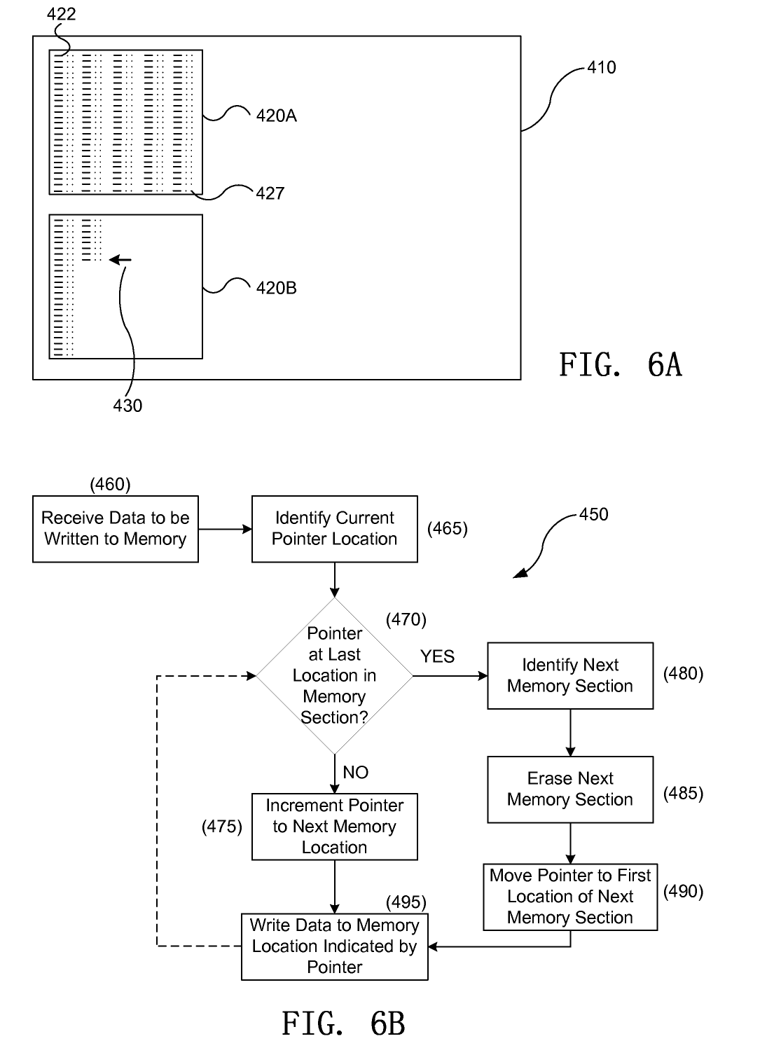

FIGS. 6A and 6B illustrate another technique of wear-leveling that focuses on list-based event writing. Here, these illustrated embodiments depict a memory apportioned into sections and a method of using list-based event writing to ensure wear leveling of the memory cells in flash memory. FIG. 6A is a functional block diagram of a memory associated with a server in a gaming system according to embodiments of the invention, and FIG. 6B is a flow diagram of a method of writing game data to a memory associated with a server in a gaming system according to embodiments of the invention.

Referring to FIG. 6A, a flash memory chip 410 is divided up into sections 420A, 420B each including multiple memory locations 422. Each memory section 420A, 420B may be a block of memory cells that are commonly erased during an erase procedure, or may include multiple memory blocks. Each memory location 422 may include one or more memory cells dedicated to storing data related to a gaming event that is to be stored. A pointer 430 keeps track of a current memory location 422. A write or program operation example will now be discussed with reference to FIGS. 6A and 6B.

Referring to FIGS. 6A and 6B, flow 450 begins with process 460 when data is received by the server that is to be written to memory. The current memory location 422 indicated by the pointer 430 is then determined in process 465. In process 470, it is determined whether the memory location 422 indicated by the pointer 430 is the last memory location 427 in a memory section 420A, 420B. If it is determined that the pointer 430 is not indicating the last memory location 427 of a memory section 420A, 420B, flow 450 proceeds to process 475 where the pointer is incremented to indicate the next memory location 422. Thereafter, the received data is written to the memory location 422 indicated by the memory pointer 430 in process 495. For received data that is too large to be written to a single memory location 422, flow 450 may return to process 470 and loop through the processes following process 470 until all of the received data is written to the memory 410.

Returning to process 470, if it is determined that the pointer is indicating the last memory location 470 of a memory section 420A, 420B, flow 450 proceeds to process 480 where the next memory section is identified. For example, if the pointer 430 was currently indicating the last memory location 427 of memory section 420A, memory section 420B may be identified as the next memory section in process 480. In embodiments where memory 410 only includes a single memory section 420, process 480 may be omitted. After the next memory section has been identified in process 480, this next identified memory section is erased in process 485. In the first example mentioned above where memory section 420B is identified as the next memory section, memory section 420B would be erased in process 485. In embodiments where memory section 420B includes only a single memory block, the entire memory section 420B would be erased in process 485. In other embodiments where memory section 420B included multiple memory blocks, one, some, or all of the memory blocks in memory section 485 may be erased. If less than all of the memory blocks are erased, additional processes would be needed to determine when the next un-erased memory section was encountered in memory section 420B and to erase that encountered memory block so that additional data could be written to that memory block. In yet other embodiments, process 485 may further include the step of copying all programmed data in the next memory block (e.g., 420B) to another memory section of memory 410 or at another remote memory location to preserve a record of the data. This need to create a backup of the memory prior to erasure may be dependent upon whether another record of necessary data is created independently of data being written to the flash memory 410. For example, necessary game data may be transmitted to a casino accounting server 165 (FIG. 1) or database at a similar time that it is being written to memory 410. In embodiments where memory 410 only includes a single memory section 420, the step of preserving another record of the data may be especially useful prior to erasing the single memory section.

After the next memory section is erased in process 485, flow 450 moves to process 490 where the pointer 430 is moved to the first location of the next erased memory section (e.g., to the first memory location of memory section 420B). After the pointer is moved to indicate a new memory location at which to write data, flow 450 moves to process 495 where the received data is written to the memory location 422 indicated by the pointer 430. Again, if the received data is too large to be written to a single memory location 422, flow 450 may return to process 470 and loop through the processes following process 470 until all of the received data is written to the memory 410.

As described above, gaming device terminals may include wireless tablet-style modules, cell phones, personal computers, and traditional-styled gaming devices that are controlled by a central gaming server. However, existing conventional gaming devices can also act as gaming device terminals that have game played controlled by a remote CGS instead of a local game processor and firmware. Below are example systems and components that may allow for server-centric gaming on existing traditional gaming devices.

FIG. 7 is a system diagram illustrating various components of a server-centric gaming system according to embodiments of the invention. Referring to FIG. 7, the gaming system 500 includes several conventional gaming devices, also referred to as Electronic Gaming Machines (EGMs) 510 that are connected to a gaming network 550 through various communication mechanisms.

In general, a gaming network 550 connects any of a number of EGMs 510, or other gaming devices, such as those described below, for central management. As described above, a central gaming server 560 may control game play on connected gaming device terminals 536, 534, 512, 572 and the EGMs 510. A database 570 may be connected to the CGS 560 and house player credit account information and/or other game play data. Accounting and other functions may be served by other servers (not shown). For example many player tracking functions, bonusing systems, and promotional systems may be centrally administrated from the other servers. In some embodiments there may be multiple servers and databases, each performing different functions. In other embodiments functions may be combined and operate on a single or small group of servers 560, each with their own database 570 or combined databases.

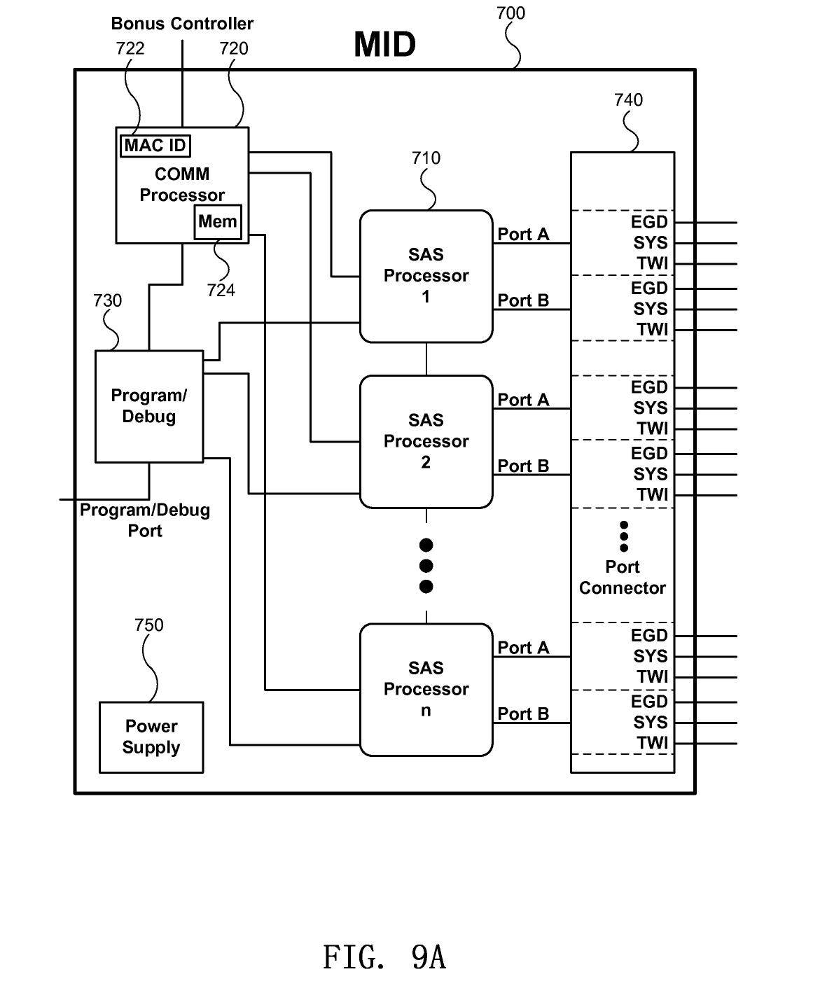

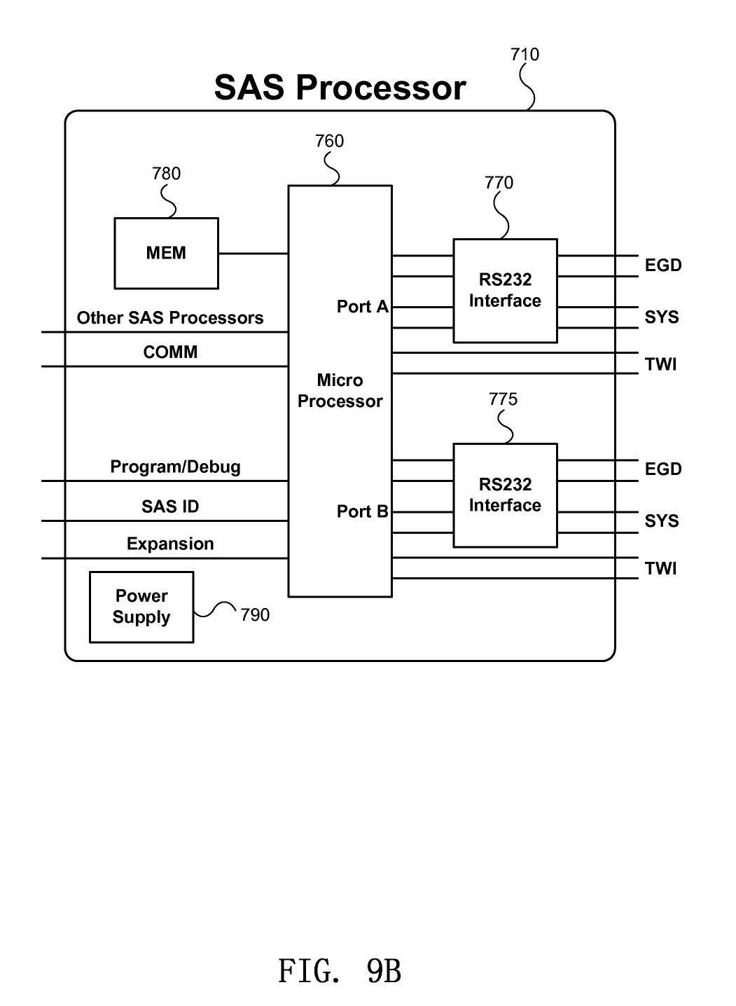

Many of the EGMs 510 of FIG. 7 connect to the gaming network 550 through a Machine Interface Device, MID 520. In general, the MID 520 is a multi-protocol interface that monitors communication between the gaming network 550 and the EGM 10. In a common embodiment, the MID 520 communicates to the EGM 510 through a standard gaming network port, using a standard gaming network protocol, SAS, which is well known in the gaming industry. Most modern games include at least one communication port, which is commonly a SAS port or a port for another communication protocol. The MID 520, along with its various functions and communication methods is described in detail with reference to FIGS. 9A and 9B below.

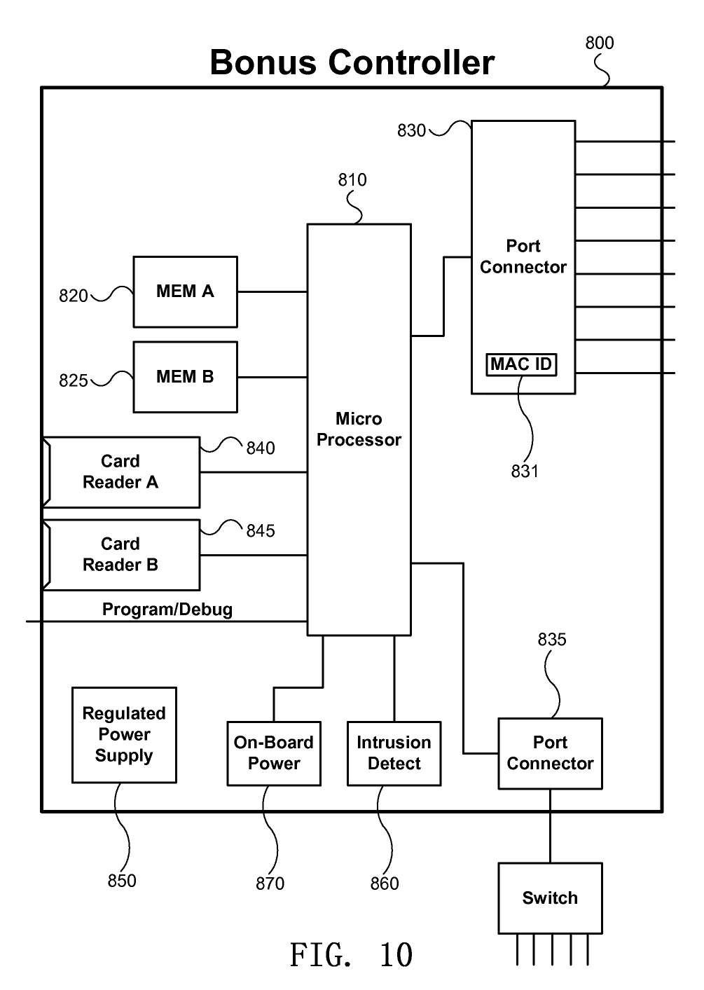

Other EGMs 510 in FIG. 7 connect to the gaming network 550 through a bonus controller 540, which may be coupled between the gaming network 550 and gaming device 510. The bonus controller 540 generally communicates through a non-SAS protocol, such as another well-known communication protocol known as GSA. GSA is typically carried over an Ethernet network, and thus the bonus controller 540 includes an Ethernet transceiver, which is described with reference to FIG. 10 below. Because the bonus controller 540 communication may be Ethernet based, a switch 530 may be used to extend the number of devices that may be coupled to the bonus controller 540. The bonus controller 540 and/or the MID 520 may create or convert data or information received according to a particular protocol, such as SAS, into data or information according to another protocol, such as GSA. In this way the MID 520 and bonus controller 540 are equipped to communicate, seamlessly, between any EGM 510 and gaming network 550 no matter which communication protocols are in use. Further, because the MID 520 and bonus controller 540 are programmable, and include multiple extensible communication methods, as described below, they are capable of communicating with EGMs 510 that will communicate using protocols and communication methods developed in the future. By using the MID 520 and/or bonus controller 540, the central gaming server 560 may regulate game play on the EGMs 510. That is, the MID 520 or bonus controller 540 may be used to directly communicate game play instructions between the CGS 560 and the processors of the traditional gaming devices 510.

The gaming device terminals that are configured to receive instructions directly from a central gaming sever 560 may also be connected to the gaming network 550 and controlled by the CGS. For instance, a GDT 512 may couple directly to the network 550 without any intervening hardware, other than hardware that is built into the GDT 512 to connect it to the network 550. In addition, a wireless transceiver 532 couples the gaming network to wireless gaming device terminals, such as a handheld GDT 536. A cellular phone 534 may additionally be connected to the gaming network though a the wireless transceiver 532, cell phone network, or other compatible data network. The cellular phone 534 may be a “smart phone,” which in essence is a handheld computer capable of playing games or performing other functions on the gaming network 550, as described in some embodiments of the invention. The gaming network 550 also couples to the internet 570, which in turn is coupled to a number of computers, such as the personal computer 572 illustrated in FIG. 7. The personal computer 572 may be used to manage player tracking or other data kept on the gaming network 550, such as a player credit account. More likely, though, is that the personal computer 572 is used to play actual games in communication with the gaming network 550 where game play is controlled by the central gaming sever 560. Player data related to games and other functions performed on the personal computer 572 may be tracked as if the player were playing on a GDT directly coupled to the gaming network 550.

As discussed above, a player kiosk 514 may also be directly coupled to the gaming network 550. The player kiosk 514 allows players, managers, or other personnel to access data on the gaming network 550, such as a player tracking record, and/or to perform other functions using the network. For example, a player may be able to check the current holdings of a player credit account, transfer balances, redeem player points for credits, cash, or other merchandise or coupons, such as food or travel coupons, for instance.

For the existing EGMs 510 connected to the server-centric gaming system 500, operation begins when a player inserts a starting credit into one of the games and initiates a game of choice. The EGM 510 sends data through its data communication port through the MID 520 and/or bonus controller 550 through the gaming network 550 to the central gaming sever 560. The CGS server 560 and database 570 may collect information about the game play on the EGM 510, such as wagers made, results, various pressing of the buttons on the EGM 510, for example. In addition, the SAS port on the EGM 510 may also be coupled, through the MID 520 as described below, to other systems, such as player tracking systems, accounting, and ticketing systems, such as Ticket-In-Ticket-Out (TITO) systems.

In response to the game initiation, the CGS 560 transfers game play and game outcome data back through the gaming network 550 to the MID 520 and/or bonus controller 550 and ultimately to the EGM 510, which carries out the instructions provide by the CGS. Game play follows a similar method as that described above with the CGS 560 controlling the EGMs 510 through the use of the MID 520 and/or bonus controller 540. In addition, the EGM 510 may accept information from other systems external to the EGM itself to cause the EGM 510 to perform other functions. For example, these external systems may drive the EGM 510 to issue additional credits to the player. In another example, a promotional server may direct the EGM 510 to print a promotional coupon on the ticket printer of the EGM.

The bonus controller 540 is structured to perform some of the above-described functions as well. For example, in addition to standard games on the EGM 510, the bonus controller 540 is structured to drive the EGM 510 to pay bonus awards to the player based on any of the factors, or combination of factors, related to the EGM 510, the player playing the EGM 510, particular game outcomes of the game being played, or other factors.

In this manner, the combination of the bonus controller 540 and MID 520 are a sub-system capable of interfacing with each of the EGMs on a gaming network 550. Through this interface, the MID 520 may gather data about the game, gameplay, or player, or other data on the EGM 510, and forward it to the bonus controller 540. The bonus controller 540 then uses such collected data as input and, when certain conditions are met, sends information and/or data to the EGM 510 to cause it to perform certain functions.

In a more detailed example, suppose a player is playing an EGM 510 coupled to the MID 520 and the bonus controller 540 described above. The player inserts a player tracking card so the gaming network 550 knows the player identity. The MID 520 also stores such identifying information, or perhaps stores only information that the player is a level-2 identified player, for instance. The MID 520 passes such information to the bonus controller 540, which has been programmed to provide a welcome-back bonus to any level-2 player after he or she has played two games. Gameplay on the EGM 510 continues and, after the player plays two games, the bonus controller 540 instructs the EGM 510 to add an additional 540 credits to the EGM 510 as the welcome-back bonus. Such monitoring and control of the EGM 510 can occur in conjunction with, but completely separate from any player tracking or bonusing function that is already present on the gaming network 550. In other words, the server 560, when structured at least in part as a bonusing server, may be set to provide a time-based bonus of 510 credits for every hour played by the player of the EGM 510. The above-described welcome-back bonus may be managed completely separately through the bonus controller 540 and MID 520. Further, all of the actions on the EGM 510 caused by the bonus controller 540 are also communicated to the standard accounting, tracking, and other systems already present on the gaming network 550.

FIG. 8 is a functional block diagram that illustrates an example gaming device that can be a part of the gaming system shown in FIG. 7. Referring to FIG. 8, the illustrated gaming device 600 is an example of the EGMs 510 that are shown in FIG. 7. These EGMs 510 may include all types of electronic gaming machines, such as physical reel slot machines, video slot machines, video poker gaming devices, video blackjack machines, keno games, and any other type of devices may be used to wager monetary-based credits on a game of chance. As mentioned above, various other types of gaming devices may be connected to the network 550 (FIG. 7) such as wireless gaming device terminal 536, computers used for gaming purposes 572, cellular phones 534, multi-player gaming stations, etc.

Returning to FIG. 8, the illustrated gaming device 600 includes a cabinet 605 to house various parts of the gaming device 600, thereby allowing certain components to remain securely isolated from player interference, while providing access to player input/output devices so that the player may interact with the gaming device. The securely housed components include the game processor 620, memory 610, and connection port 630. The game processor 620, depending on the type of gaming device 600, may completely or partially control the operation of the gaming device in normal operation (i.e., if it was not connected to a server-centric gaming system). For example, if the gaming device 600 is a standalone gaming device, game processor 620 may control virtually all of the operations of the gaming device and attached equipment. In other configurations, the game processor 620 may implement instructions generated by or communicated from the central gaming server (e.g., server 560 shown in FIG. 7) or other controller. In yet other embodiments, where a gaming network is a hybrid server-centric gaming system, the game processor 620 may be responsible for running a base game of the gaming device 600 and executing instructions received over the network 550 from the CGS server 560 relating to bonus play, portions of the base game play, or other aspects of game play.

The memory 610 is connected to the game processor 620 and may be configured to store various game information about game play or player interactions with the gaming device 600. This memory may be volatile (e.g., RAM), non-volatile (e.g., flash memory), or include both types of memory. The connection port 630 is also connected to the game processor 620. This connection port 630 typically connects the gaming device 600 to a gaming network, such as the gaming network 550 described above. The connection port 630 may be structured as a serial port, parallel port, Ethernet port, optical connection, wireless antenna, or any other type of communication port used to transmit and receive data. Although only one connection port 630 is shown in FIG. 8, the gaming device 600 may include multiple connection ports. As described above, in many existing gaming devices, this connection port 630 is a serial connection port utilizing a SAS protocol to communicate to one or more remote game servers, such as player tracking servers, bonus servers, accounting servers, etc.

The player input/output devices housed by the gaming cabinet 605 include a game display 630, a button panel 640 having one or more buttons 645, a ticket printer 650, a bill/ticket reader 670, a credit meter 675, a player club interface device 660, and one or more game speakers 695. Various gaming devices may include fewer or more input/output devices (e.g., a game handle, a coin acceptor, a coin hopper, etc.) depending upon the configuration of the gaming device.

The gaming display 630 may have mechanical spinning reels, a video display, or include a combination of both spinning reels and a video display, or use other methods to display aspects of the gameplay to the player. If the gaming display 630 is a video display, the gaming display may include a touch screen to further allow the player to interact with game indicia, soft buttons, or other displayed objects. The button panel 640 allows the player to select and place wagers on the game of chance, as well as allowing the player to control other aspects of gaming. For example, some gaming devices allow the player to press a button 645 to signal that he or she requires player assistance. Other buttons may bring up a help menu and/or game information. The buttons 645 may also be used to play bonuses or make selections during bonus rounds.

Ticket printers 650 have relatively recently been included on most gaming devices to eliminate the need to restock coin hoppers and allow a player to quickly cash-out credits and transfer those credits to another gaming device. The tickets can also typically be redeemed for cash at a cashier cage or kiosk. The ticket printers are usually connected to the game processor and to a remote server, such as a TITO server to accomplish its intended purpose. In gaming devices that have more than one peripheral device, and which include only a single SAS port, the peripheral devices all share communication time over the connection port 630.

Another peripheral device that often requires communication with a remote server is the player club interface device 660. The player club interface device 660 may include a reader device and one or more input mechanisms. The reader is configured to read an object or indicia identifying the player. The identifying object may be a player club card issued by the casino to a player that includes player information encoded on the card. Once the player is identified by a gaming device, the player club interface device 660 communicates with a remote player server through the connection port 630 to associate a player account with the gaming device 600. This allows various information regarding the player to be communicated between the gaming device 600 and the player server, such as amounts wagered, credits won, and rate of play. In other embodiments, the card reader may read other identifying cards (such as driver licenses, credit cards, etc.) to identify a player. Although FIG. 8 shows the reader as a card reader, other embodiments may include a reader having a biometric scanner, PIN code acceptor, or other methods of identifying a player so as to pair the player with their player tracking account. As is known in the art, it is typically advantageous for a casino to encourage a player to join a player club since this may inspire loyalty to the casino, as well as give the casino information about the player's likes, dislikes, and gaming habits. To compensate the player for joining a player club, the casino often awards player points or other prizes to identified players during game play.

Other input/output devices of the gaming device 600 include a credit meter 675, a bill/ticket acceptor 670, and speakers 695. The credit meter 675 generally indicates the total number of credits remaining on the gaming device 600 that are eligible to be wagered. The credit meter 675 may reflect a monetary unit, such as dollars, or an amount of credits, which are related to a monetary unit, but may be easier to display. For example, one credit may equal one cent so that portion of a dollar won can be displayed as a whole number instead of decimal. The bill/ticket acceptor 670 typically recognizes and validates paper bills and/or printed tickets and causes the game processor 620 to display a corresponding amount on the credit meter 675. The speakers 695 play auditory signals in response to game play or may play enticing sounds while in an “attract-mode,” when a player is not at the gaming device. The auditory signals may also convey information about the game, such as by playing a particularly festive sound when a large award is won.

The gaming device 600 may include various other devices to interact with players, such as light configurations, top box displays 690, and secondary displays 680. The top box display 690 may include illuminated artwork to announce a game style, a video display (such as an LCD), a mechanical and/or electrical bonus display (such as a wheel), or other known top box devices. The secondary display 680 may be a vacuum fluorescent display (VFD), a liquid crystal display (LCD), a cathode ray tube (CRT), a plasma screen, or the like. The secondary display 680 may show any combination of primary game information and ancillary information to the player. For example, the secondary display 680 may show player tracking information, secondary bonus information, advertisements, or player selectable game options. The secondary display may be attached to the game cabinet 605 or may be located near the gaming device 600. The secondary display 680 may also be a display that is associated with multiple gaming devices 600, such as a bank-wide bonus meter, or a common display for linked gaming devices.

In operation, typical play on a gaming device 600 commences with a player placing a wager on a game to generate a game outcome. In some games, a player need not interact with the game after placing the wager and initiating the game, while in other games, the player may be prompted to interact with the gaming device 600 during game play. Interaction between the player and the gaming device 600 is more common during bonuses, but may occur as part of the game, such as with video poker. Play may continue on the gaming device 600 until a player decides to cash out or until insufficient credits remain on the credit meter 675 to place a minimum wager for the gaming device.

Communication between gaming devices, such as those described above, and other devices on gaming systems 500 (FIG. 7) is becoming increasingly more complex. The below-described system illustrates a system and method of communication on modern and future gaming systems.

FIG. 9A is a block diagram of a MID 700, which may be an example of the MID 520 described with reference to FIG. 7 above. The MID 700 includes a set of processors 710, which in this example are termed SAS processors. These SAS processors are capable of accepting, manipulating, and outputting data on a SAS protocol network.

The MID 700 is capable of communicating using other communication protocols as well, as described below. Each processor 710 is structured to couple to two Electronic Gaming Devices (EGDs). EGDs may include, for example, gaming devices such as EGM 510 of FIG. 7, or other electronic gaming devices. In the illustrated embodiment, each SAS processor 710 includes two ports, A and B, each of which may be coupled to an EGD. In turn, the two ports A and B are attached to a set of physical connectors, illustrated here as a single connector 740 for convenience of explanation. Each section of the physical connector 740, delineated by dotted lines, includes three separate pairs of communication lines. Each pair of communication lines is illustrated as a single line—a first serial pair labeled EGD, a second serial pair labeled SYS, and a third communication pair that uses two-wire communication, labeled TWI. Note that each of the ports A and B of the SAS processor 710 includes all three communication pairs. Additionally each of the sections of the physical connector 740 includes wires for a voltage and ground reference, though not depicted in FIG. 9A. In an embodiment of the MID 700 with four SAS processors 710, the physical connector 740 includes up to eight sections, each of which may be embodied by a separate, standard, RJ-45 connector to couple to a matching RJ-45 port in the connected EGM 510, or EGD, as determined by the specific implementation.

As illustrated in FIG. 9A, the first serial pair of Port A couples to EGD. The second serial pair may be coupled to external devices connected to the EGD, as needed. Specifically, some serial data protocols, such as SAS, do not allow EGMs 510 to interface with multiple external devices over a single serial communication path. Such external devices may include, for example, player tracking systems and accounting systems. If a particular EGM 510 is already connected to such a system, and thus its SAS port is “full,” the MID 700, and in particular a SAS processor 710, may insert itself “between” the connected system and the EGM 510 by using both of the serial pairs in a particular port of the SAS processor 710 to couple to the EGM 510 and the other connected system, respectively. In operation, the MID 700, through the respective SAS processor 710, passes any information directed from the external device coupled to the SYS communication lines in a particular port to the EGD of the same port, or vice-versa, in real time and without interruption. For example, polls, requests for information, and transmission of information are passed from a connected player tracking system, through the SYS lines of Port A to the serial line EGD of Port A. Only a small communication delay is added using such a communication system, which is well within the tolerance limits of SAS protocol. As a result, both the EGM 510 and external system behave as if the MID 700 were not present. Further, the third communication pair, a two-wire interface labeled TWI, presents opportunity for expansion to future systems installed on the EGM 510, or a new EGM, so that any data may be communicated between the EGM 510 and the MID 700. The TWI may be connected to card readers, top boxes, ticket dispensers, lighting panels, etc. that are coupled to or work in conjunction with an EGM 510.

Besides simply passing information between communication interfaces, the MID 700 also generates information directly for connected EGDs, which may originate from the MID 700 or from another device as described below. In such a case the SAS processor 710 sends the appropriate data through its appropriate serial line or two-wire interface directly to the desired EGD. Then the EGD may send its own data to its connected peripheral.

Referring back to FIG. 9A, the MID 700 additionally includes a communication processor 720, labeled as COMM processor. The communication processor 720 is coupled to each of the SAS processors 710, a program/debug circuit 730, and to a bonus controller 540 (FIG. 7). In practice, the communication processor 720 may be embodied by a small microprocessor, such as the Atmel ATXMEGA256A3, which is readily available to developers, or any other processor or system capable of performing the desired communication functions.

The communication processor 720 collects and aggregates information from the EGDs that are coupled to each of the SAS processors 710 and sends the aggregated information to the bonus controller 540 of FIG. 7. In some embodiments the communication processor 720 is coupled to the bonus controller 540 through an Ethernet interface. The communication processor is structured to parse information from Ethernet data packets and collect it for use by other systems within the MID 700. Because Ethernet is an addressed protocol, by which messages may be sent to a particular Ethernet address, the communication processor 720 also includes an address of the Ethernet device in a MAC ID 722.

The communication processor 720 may also accept information from the bonus controller 540, or other connected devices, and pass such information to the EGDs coupled to the SAS processors 710. The information may include data, instructions, or commands, for instance.

A memory 724, which may be, for instance Ferroelectric Random Access Memory (FRAM) capable of retaining stored contents for over 10 years may be used by the communication processor for both program and data storage. Of course, other memory technologies may be used instead of or in addition to FRAM.

A program/debug circuit 730 in the MID 700 connects to the communication processor 720 as well as to each of the SAS processors 710. During manufacture of the MID 700, the programming functions of the program/debug circuit 730 load program code to each of the SAS processors 710 as well as the communication processor 720. This initial loading may take place through a program/debug communication port. Further, the program codes stored in each of the SAS processors 710 and the communication processor 730 may be updated through commands and data sent from an external device, such as the bonus controller 540, through the communication processor 720 to the program/debug circuit 730. The program/debug circuit 730 then formats the updated program data for each of the connected SAS processors 710 and communication processor 720, and sends a command to each of the processors to be updated to load the new program code.

FIG. 9B is a block diagram of one of the SAS processors 710 of FIG. 9A, which shows additional detail of the SAS processor.

As described above, each of the SAS processors 710 include two separate ports, Port A and Port B, illustrated here as separate ports of a microprocessor 760. The microprocessor 760 in the SAS processor 710 may be embodied by an Atmel ATXMEGA256A3, as described above.

Each of the ports of the microprocessor 760 is structured to couple to an EGD, which may be an EGM 510 of FIG. 7. Each port of the microprocessor 760 includes two serial connections, which in the example embodiment illustrated in FIG. 9B, are RS-232 ports common in the computing industry. The RS-232 ports are contained in an RS-232 interface 770, 775, one for each port of the microprocessor 760. Each of the interfaces 770, 775 includes two separate RS-232 ports, each of which uses a separate transmit and receive wire. Thus, each interface 770, 775 includes a total of four wires. It is convenient to include RS-232 ports as the preferred mode of communication because it is the standard interface for SAS ports of the EGMs 510. In non-standard EGMs 510, such as very old or future devices that may not include SAS ports, communication ports other than RS-232 may be used simply by exchanging or updating the RS-232 interfaces 770, 775. Another possibility is to include an RS-232 translator in any EGM 510 that does not include its own RS-232 interface. As illustrated in FIG. 9B, and as described above, the first of the serial connections, labeled EGD, is connected to an EGD for the particular port of the microprocessor 760, while the second serial connection, labeled SYS is connected to external devices that may be coupled to the particular EGD.

Additionally, and as described above, each SAS processor 710 includes two, two-wire interfaces, illustrated as a separate interface pair and labeled as TWI. In this embodiment, there is one pair for each port of the microprocessor 760. Each two-wire interface creates a bi-directional serial port that may be used for communicating with peripheral or expansion devices associated with the EGD of the particular microprocessor 760, or with other devices on the gaming system 500 of FIG. 7.

The SAS processor 710 includes a memory 780 for storing instruction data of the microprocessor 760 as well as providing data storage used by the SAS processor. The memory 780 is preferably non-volatile memory, such as FRAM that is connected to the microprocessor 760 through a serial interface.

As described above, the SAS processor 710 of the MIB 700 (FIG. 9A) includes multiple connections to other components in the MIB 700, which are illustrated in detail in FIG. 9B. Initially, each SAS processor 710 is coupled to each of the other SAS processors 710 in the MIB 700. In practice, this may accomplished by a direct connection, in which each microprocessor 760 is directly coupled to one another, or such connection may be an indirect connection. In an indirect connection, the microprocessors 760 of each SAS processor 710 is coupled to the communication processor 720 (FIG. 9A). Any data or information to be shared between SAS processors 710 is then originated by or passed through the communication processor 720 to the other SAS processors.

Similarly, as described above, the microprocessor 760 of each SAS processor 710 is coupled to a program/debug circuit 730 for initial or later programming. To communicate with each SAS processor 710 individually, each SAS processor is given an individual identification number, which may be set for the microprocessor 760 by tying particular data pins of the microprocessor to permanent low or high signals. Using binary encoding, n individual lines are used to identify 2n separate processors. A set of expansion pins couples to the microprocessor 760 of each SAS processor 710 so that each processor may determine system identification and revisions of the MIB 700 and the connected bonus controller 540.

With reference back to FIG. 7, recall that the bonus controller 540 couples to each of the MIDs 700, and by extension to their coupled EGDs, such as EGMs 510, and possibly to one or more EGMs themselves, to cause data and commands to be sent to the EGMs to control functions on each EGM. FIG. 10 is a detailed block diagram of such a bonus controller, according to embodiments of the invention.

A bonus controller 800 of FIG. 10 may be an embodiment of the bonus controller 540 illustrated in FIG. 7. Central to the bonus controller 800 is a microprocessor 810, which may be an Atmel AT91SAM9G20, which is readily available to developers.

The microprocessor 810 is coupled to one or more memory systems 820, 825. A memory system 820 is a 2 Megabyte FRAM while memory system 825 is a 64 Megabyte Synchronous DRAM (SDRAM). Each memory system 820, 825 has various advantages and properties and is chosen for those properties. FRAM maintains its data autonomously for up to ten years, while SDRAM is relatively fast to move data into and out of, as well as being relatively inexpensive. Of course, the sizes and types of memory included in any bonus controller according to embodiments of the invention may be determined by the particular implementation.

The microprocessor 810 also couples to a pair of card readers, 840, 845, which are structured to accept easily replaceable, portable memory cards, as are widely known. Each card reader may further include Electro-Static Discharge (ESD) devices to prevent damage to internal circuitry, such as the microprocessor 810, when cards are inserted or removed from the card readers 840, 845. In practice, a card in one of the card readers 840, 845 may store program code for the microprocessor 810 while a card in the other reader may store data for use by the bonus controller 800. Alternatively a single card in either of the card readers 840, 845 may store both program and data information.

A port connector 830 includes multiple communication ports for communicating with other devices. With reference back to FIG. 9A, the communication processor of each MID 700 couples to a connected bonus controller through such a communication port. The communication port 830 is preferably an Ethernet interface, as described above, and therefore additionally includes a MAC address 831. The port connector 830 includes multiple separate connectors, such as eight, each of which connect to a single MID 520 (FIG. 7), which in turn connects to up to eight separate EGMs 510. Thus, a single bonus controller 800 may couple to sixty-four separate EGMs by connecting through appropriately connected MIDs.

Further, a second port connector 835 may be included in the bonus controller 800. The second port connector may also be an Ethernet connector. The purpose of the second port connector 835 is to allow additionally connectivity to the bonus controller 800. In most embodiments the second port connector 835 may couple to another bonus controller 800 or to other server devices, such as the server 560 on the gaming network 550 of FIG. 7. In practice, the second port connector 835 may additionally be coupled to a MID 520, thus providing the bonus controller 800 with the ability to directly connect to nine MIDs 520.

Yet further, Ethernet connections are easily replicated with a switch, external to the bonus controller 800 itself, which may be used to greatly expand the number of devices to which the bonus controller 800 may connect.

Because the bonus controller 800 is intended to be present on a gaming network 550, and may be exposed to the general public, systems to protect the integrity of the bonus controller 800 are included. An intrusion detection circuit 860 signals the processor 810 if a cabinet or housing that contains the bonus controller 800 is breached, even if no power is supplied to the bonus controller 800. The intrusion detection circuit may include a magnetic switch that closes (or opens) when a breach occurs. The microprocessor 810 then generates a signal that may be detected on the gaming network 550 indicating that such a breach occurred, so that an appropriate response may be made. An on-board power circuit 870 may provide power to the bonus controller 800 for a relatively long time, such as a day or more, so that any data generated by the processor 810 is preserved and so that the processor 810 may continue to function, even when no external power is applied. The on-board power circuit 870 may include an energy-storing material such as a battery or a large and/or efficient capacitor.

Similar to the microprocessor processor 760 of the SAS processor 710 described above, the microprocessor 810 of the bonus controller 800 is additionally coupled to a program/debug port for initially programming the microprocessor 810 during production, and so that program and/or other data for the microprocessor may be updated through the program/debug port. In operation the bonus controller 800 configures and controls bonus features on gaming devices through a gaming network 550 or through other communication systems. Bonus features are implemented through each gaming device's internal structure and capabilities, and may include integration with additional peripheral devices. Bonusing programs for the connected games may be introduced to the bonus controller 800 by updating data stored in the memory systems directly on the bonus controller, or by inserting new memory cards in one or more of the card readers 840, 845. Such a platform provides a facility for game developers, even third-party developers, to define and program new types of bonus games that may be used in conjunction with existing EGMs on existing gaming networks, or on new games and new networks as they are developed. These bonus controllers 800 may be used as part of a server-centric gaming system, such as the ones described above, by controlling bonuses independent of normal game play that is controlled by the central gaming sever. In embodiments that use a hybrid server-centric architecture, the bonus controller 800 may control some bonuses, while the internal game processor in the EGM controls portions of the base game. The CGS in these systems may control other aspects of the base game, other bonus games, or various other game play functions. For example, an internal game processor may implement a random outcome generated by the CGS in game data stored on local memory in the EGM, while the bonus controller may control a mystery bonus related to a group of connected gaming devices, such as a Lucky Coin mystery bonus.

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out in the appended claims.

1. A gaming system comprising:
a central game server including
a first plurality of circuit cards each having a processor and a memory, and
a second plurality of circuit cards each having a processor and a memory, where each of the second plurality of circuit cards includes substantially identical data to one of the first plurality of circuit cards; and
a game device terminal connected to the central game server though a first network, wherein game play on the game device terminal is controlled by at least one of the processors at the central game server.

2. The gaming system of claim 1, further comprising a player credit terminal connected to the central game server through a second network, the player credit terminal configured to receive credits input by a player.

3. The gaming system of claim 2, wherein the player credit terminal is housed in a structure with the game device terminal.

4. The gaming system of claim 2, wherein the player credit terminal is a player-accessible kiosk located in a casino.

5. The gaming system of claim 4, wherein the player credit terminal is further configured to disperse one of a redeemable credit ticket or cash in response to a player request to cash-out available credits.

6. The gaming system of claim 2, wherein the player terminal includes a player identification device configured to identify a player that is a member of a loyalty club.

7. The gaming system of claim 6, wherein the player identification device is a card reader configured to read data on a player club card and retrieve player data from a player club database over the first network.

8. The gaming system of claim 2, wherein the player terminal includes a game device connection port configured to connect to a game device terminal.

9. The gaming system of claim 8, wherein the player terminal is configured to add or remove credits from a connected game device terminal in response to a player request at the player terminal.

10. A method of operating a gaming system, the method comprising:
receiving a signal from a game device terminal to initiate a gaming event;
deducting a wagered amount of credits from a player credit account;
determining a game outcome for the gaming event;
providing instructions to the game device terminal for implementing the gaming event at the game device terminal;
incrementing a player credit account by any prize associated with the determined game outcome; and
updating a credit meter at the gaming device terminal.

11. The method of claim 10, further comprising:
identifying a player playing the game device terminal; and
associating a player credit account linked to the identified player to the game device terminal.

12. The method of claim 11, further comprising incrementing the associated player credit account by any credits input by a player at a casino help desk, at a player kiosk, or at a credit input device connected to the game device terminal.

13. The method of claim 11, further comprising decrementing the associated player credit account by any credits requested to be cashed out or otherwise used for purchasing goods or services.

14. The method of claim 10, wherein providing instructions to the game device terminal for implementing the gaming event at the game device terminal includes providing instructions for displaying each step of the gaming event and displaying the game outcome.

15. A method of selecting and playing a new game on a gaming system, the method comprising:
receiving an input at a game device terminal to display a list of available games;
displaying the list of available games at the game device terminal;
receiving a selection of one of the available games from the list;
downloading an initial game data package to a memory in the game device terminal, the initial game package including graphical data for the selected game;
transmitting a request for game play to a central gaming server in response to receiving a game initiating input;
receiving game play instructions and a game outcome from the central gaming server; and
displaying the game according to the received game play instructions from the central gaming server.

16. The method of claim 15, wherein downloading an initial game data package includes downloading a graphical interface for the selected game.

17. The method of claim 15, wherein downloading an initial game data package includes downloading stationary graphics, video graphics, and sounds used in game play.

18. The method of claim 17, wherein receiving game play instructions includes providing instructions for which downloaded graphic and sound data to use during the gaming event.

19. The method of claim 15, wherein displaying the list of available games at the game device terminal includes ordering the list of available games based on stored preferences of a player.

20. A gaming device having enhanced game information, the gaming device comprising:
a gaming display;
a player input device; and
a processor configured to implement a list of game reviews on the gaming display in response to activation of the player input device.

21. The gaming device of claim 20, further comprising at least one player input device configured to initiate a gaming event on the gaming device.

22. The gaming device of claim 20, wherein the processor is further configured to receive a review submitted by a player at the gaming device.

23. The gaming device of claim 22, further comprising a player input interface configured to receive player inputs to create a game review.

24. A gaming system comprising:
a central game server;
a wireless game device terminal connected to the central game server though a network, the wireless game device terminal including at least one battery to provide power to the wireless game device terminal, wherein game play on the game device terminal is controlled by the central game server; and
a docking station positioned within a gaming establishment and configured to receive the wireless gaming device terminal, the docking station configured to recharge the at least one battery of the wireless game device terminal.

25. The gaming system of claim 24, wherein the docking station is positioned on a game floor of the gaming establishment.

26. The gaming system of claim 24, wherein the docking station includes a bill acceptor and a ticket printer.

27. The gaming system of claim 24, wherein the docking station includes a player club input device configured to identify a player to the gaming system.

28. The gaming system of claim 24, wherein the docking station is connected to the central game server via the game network.

29. The gaming system of claim 28, wherein the wireless game device terminal connects to the central game server through the docking station when the wireless game device terminal is connected to the docking station.

30. The gaming system of claim 24, wherein the docking station includes a game display.

31. The gaming system of claim 30, wherein the game display of the docking station includes a plurality of mechanical spinning reels.

32. The gaming system of claim 31, wherein the game display of the docking station is a bonus display used with a bonus game played on the wireless game device terminal.
